(19) United States
(12) Patent Application Publication
(10) Pub. No.: US 2026/0003316 A1
(43) Pub. Date: Jan. 1, 2026

(54) FINE-PARTICLE-CAPTURING DEVICE AND POWDER-PROCESSING SYSTEM INCLUDING THE SAME

(71) Applicant: FUJIFILM Business Innovation Corp., Tokyo (JP)

(72) Inventor: Yoshitaka KURODA, Kanagawa (JP)

(73) Assignee: FUJIFILM Business Innovation Corp., Tokyo (JP)

(21) Appl. No.: 19/033,290

(22) Filed: Jan. 21, 2025

(30) Foreign Application Priority Data
Jul. 1, 2024 (JP) 2024-106254

(51) Int. Cl. G03G 21/10; G03G 15/20; G03G 21/20

(52) U.S. Cl. CPC G03G 21/10; G03G 15/2017; G03G 21/206

(57) ABSTRACT

A fine-particle-capturing device includes: a support unit made of metal and disposed near a fine-particle source capable of generating fine particles in a vaporized state; an exhaust unit having an exhaust opening that opens in the support unit made of metal, the exhaust unit causing air containing the fine particles generated by the fine-particle source to flow in a discharging direction from the exhaust opening; and a capturing component provided to cover the exhaust opening of the exhaust unit, the capturing component capturing the fine particles. The capturing component includes: a capturing unit including a plate-shaped member made of metal in which micropores are regularly arranged, the micropores extending through the plate-shaped member in a thickness direction and having a polygonal cross-section; and a holding unit made of metal having a cavity at least in a region between the capturing unit and the exhaust opening, the holding unit holding the capturing unit at a location separated from the exhaust opening. The holding unit is supported by the support unit at a downstream location in a direction in which the air passes through the capturing unit.

### CROSS-REFERENCE TO RELATED APPLICATIONS

This application is based on and claims priority under 35 USC 119 from Japanese Patent Application No. 2024-106254 filed Jul. 1, 2024.

### BACKGROUND

### (i) Technical Field

The present disclosure relates to a fine-particle-capturing device and a powder-processing system including the fine-particle-capturing device.

### (ii) Related Art

A known powder-processing system including a fine-particle-capturing device according to the related art is described in, for example, Japanese Unexamined Patent Application Publication No. 2017-120284 and Japanese Unexamined Patent Application Publication No. 2018-077295.

Japanese Unexamined Patent Application Publication No. 2017-120284 (Description of Embodiments, FIG. 3) discloses an image forming apparatus including a duct into which air is drawn from an entrance of a nip portion between a pair of rotating bodies included in a fixing device; a filter that collects fine particles generated due to a releasing agent; and a “fan provided in the duct to draw in air. The filter is an electrostatic nonwoven filter, and the fan is controlled such that the amount of air drawn is greater in a second period subsequent to a first period than in the first period.

Japanese Unexamined Patent Application Publication No. 2018-077295 (Description of Embodiments, FIG. 4) discloses an image forming apparatus including a frame having a ventilation opening and containing nip-forming members; a fan that draws out air from the inside of the frame through the opening; and a member (a wire mesh or metal springs) provided between the opening and the fan to facilitate collision between particles of vaporized wax generated when an image is heated.

### SUMMARY

Aspects of non-limiting embodiments of the present disclosure relate to a fine-particle-capturing device capable of efficiently solidifying and capturing fine particles in a vaporized state using a capturing component that does not require replacement, and a powder-processing system including the fine-particle-capturing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fine-particle-capturing device including: a support unit made of metal and disposed near a fine-particle source capable of generating fine particles in a vaporized state; an exhaust unit having an exhaust opening that opens in the support unit made of metal, the exhaust unit causing air containing the fine particles generated by the fine-particle source to flow in a discharging direction from the exhaust opening; and a capturing component provided to cover the exhaust opening of the exhaust unit, the capturing component capturing the fine particles. The capturing component includes: a capturing unit including a plate-shaped member made of metal in which micropores are regularly arranged, the micropores extending through the plate-shaped member in a thickness direction and having a polygonal cross-section; and a holding unit made of metal having a cavity at least in a region between the capturing unit and the exhaust opening, the holding unit holding the capturing unit at a location separated from the exhaust opening. The holding unit is supported by the support unit at a downstream location in a direction in which the air passes through the capturing unit.

### BRIEF DESCRIPTION OF THE DRAWINGS

Exemplary embodiments of the present disclosure will be described in detail based on the following figures, wherein:

FIG. 1A schematically illustrates a powder-processing system according to an exemplary embodiment including a fine-particle-capturing device to which the present disclosure is applied, FIG. 1B illustrates a capturing component illustrated in FIG. 1A, and FIG. 1C illustrates a capturing unit illustrated in FIG. 1B viewed in the direction of arrow IC;

FIG. 2 illustrates the overall structure of an image forming system serving as a powder-processing system according to a first exemplary embodiment;

FIG. 3 is a perspective view illustrating an example of an exhaust structure disposed near a fixing device according to the first exemplary embodiment;

FIG. 4 is a partially sectioned view of FIG. 3 taken along line IV-IV;

FIG. 5 is a plan view of FIG. 3 viewed in the direction of arrow V;

FIG. 6 illustrates an example of the structure of a capturing component included in the exhaust structure disposed near the fixing device according to the first exemplary embodiment;

FIG. 7A is a perspective view of the capturing component illustrated in FIG. 6, FIG. 7B illustrates an example of the structure of an attachment portion to which the capturing component is attached, and FIG. 7C is an exploded view of the capturing component;

FIG. 8A illustrates an example of the structure of a filter serving as a capturing unit, FIG. 8B is an enlarged view of part VIIIB in FIG. 8A, and FIG. 8C illustrates the filter viewed in the direction of arrow VIIIC in FIG. 8A;

FIG. 9A illustrates a cross-section of the capturing component, and FIG. 9B illustrates the operation of the capturing component;

FIG. 10A illustrates the principle of capturing fine particles with the capturing component, FIG. 10B is a cross-sectional view of the capturing component taken along a longitudinal direction, and FIG. 10C illustrates the negative pressure distribution along a cavity in the capturing component;

FIG. 11 illustrates an example of the structure of a capturing component included in an exhaust structure disposed near a fixing device according to a first comparative example;

FIG. 12 illustrates an example of the structure of a capturing component included in an exhaust structure disposed near a fixing device according to a second exemplary embodiment;

FIG. 13A is a perspective view of the capturing component according to the second exemplary embodiment, and FIG. 13B is an exploded view of the capturing component;

FIG. 14A illustrates an example of the manner in which a filter is attached to a first holder, FIG. 14B illustrates the filter attached to the first holder, viewed in the direction of arrow XIVB in FIG. 14A, and FIG. 14C illustrates a modification of the first holder;

FIG. 15A illustrates the manner in which the filter is attached to a second holder, FIG. 15B illustrates an example of the manner in which the filter is fixed to the second holder, and FIG. 15C illustrates an example of airtight sealing between the second holder and a periphery of the filter;

FIG. 16A illustrates the operation of the capturing component according to the second exemplary embodiment, and FIG. 16B illustrates a modification of the capturing component according to the second exemplary embodiment;

FIG. 17 illustrates an example of the structure of a capturing component included in an exhaust structure disposed near a fixing device according to a third exemplary embodiment;

FIG. 18 is an exploded view of the capturing component according to the third exemplary embodiment;

FIG. 19 illustrates an example of the structure of a capturing component included in an exhaust structure disposed near a fixing device according to a fourth exemplary embodiment; and

FIG. 20 is an exploded view of the capturing component according to the fourth exemplary embodiment.

### DETAILED DESCRIPTION

### Summary of Exemplary Embodiments

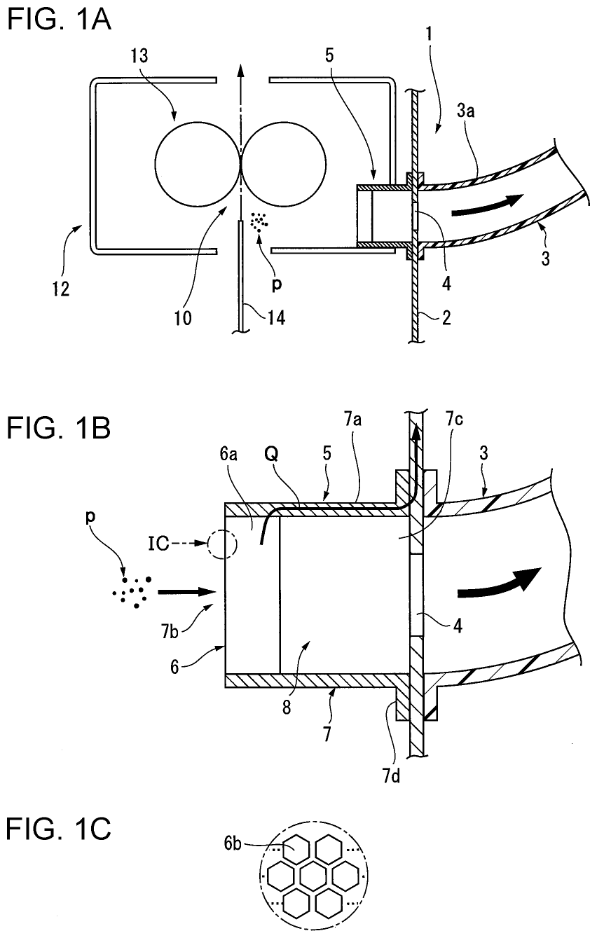

FIG. 1A schematically illustrates a powder-processing system according to an exemplary embodiment including a fine-particle-capturing device to which the present disclosure is applied.

In FIG. 1A, the powder-processing system includes a processing unit 12 and a capturing device 1 for capturing fine particles p. The processing unit 12 includes a fine-particle source 10 that generates the fine particles p in a vaporized state. The processing unit 12 processes a processing medium 14 by using powder containing the fine particles p. The fine-particle-capturing device 1 captures the fine particles p generated by the fine-particle source 10.

The powder-processing system may process the processing medium 14 using the powder containing the fine particles p. Typically, the powder-processing system is an image forming system that forms an image using toner as the powder. Alternatively, the powder-processing system may be, for example, a powder-coating system for coating a processing medium 14 using the powder.

An image forming system serving as the powder-processing system will now be described.

The processing unit 12 may include an image forming unit (not illustrated) and a fixing unit 13. The image forming unit forms an image on a recording medium serving as the processing medium 14 by using toner as the powder containing wax as the fine particles p. The fixing unit 13 heats the image formed on the recording medium by the image forming unit to fix the image. When the fixing unit 13 performs the fixing process, the wax serving as the fine particles p is vaporized. Thus, in the present exemplary embodiment, the fixing unit 13 serves as the fine-particle source 10. Therefore, the fine-particle-capturing device 1 is to be disposed near the fixing unit 13.

In this example, the fine-particle-capturing device 1 is structured as described below.

Specifically, the fine-particle-capturing device 1 includes a support unit 2 made of metal, an exhaust unit 3, and a capturing component 5 that captures fine particles p.

The support unit 2 made of metal is to be disposed near the fine-particle source 10 capable of generating the fine particles p in a vaporized state. The exhaust unit 3 has an exhaust opening 4 that opens in the support unit 2 made of metal. The exhaust unit 3 allows air containing the fine particles p generated by the fine-particle source 10 to flow in a discharging direction from the exhaust opening 4.

The capturing component 5 is disposed to cover the exhaust opening 4 of the exhaust unit 3, and captures the fine particles p. The capturing component 5 includes components described below.

Specifically, as illustrated in FIG. 1B, the capturing component 5 includes a capturing unit 6 and a holding unit 7 that holds the capturing unit 6. The capturing unit 6 includes a plate-shaped member 6a made of metal in which micropores 6b are regularly arranged, the micropores 6b extending through the plate-shaped member 6a in a thickness direction and having a polygonal cross section. The holding unit 7 has a cavity 8 at least in a region between the capturing unit 6 and the exhaust opening 4, and the holding unit 7 holds the capturing unit 6 at a location separated from the exhaust opening 4. In addition, the holding unit 7 is formed of a member made of metal, and is supported by the support unit 2 at a downstream location in a direction in which air passes through the capturing unit 6.

In the above-described technical means, the capturing device 1 is designed to solidify and capture the fine particles p in a vaporized state. In this example, ultra-fine particles (UFPs) having a particle size of 100 nm (0.1 μm) or less are captured. A typical example of ultra-fine particles is wax contained in toner. However, particles to be captured in this example are not limited to ultra-fine particles, and may include a variety of fine particles p capable of being vaporized.

The support unit 2 is, for example, a housing frame made of metal that constitutes a housing in which devices of the powder-processing system are mounted.

In addition, the exhaust unit 3 includes a flow-passage-defining unit 3a that defines an exhaust air flow passage with the exhaust opening 4 serving as an inlet. An airflow-generating unit (a fan or a pressure reducer) for generating an exhaust airflow may be provided in the flow passage defined by the flow-passage-defining unit 3a. The exhaust opening 4 is not limited to a rectangular hole, and may be a rectangular cutout. The flow-passage-defining unit 3a may be made of a synthetic resin or the like.

The capturing component 5 includes the capturing unit 6 and the holding unit 7. As illustrated in FIG. 1C, the capturing unit 6 includes the plate-shaped member 6a made of metal in which the micropores 6b having a predetermined shape are regularly arranged.

The holding unit 7 is made of metal and holds the capturing unit 6 such that the cavity 8 is provided between the capturing unit 6 and the exhaust opening 4. In this case, the holding unit 7 typically has a tubular structure that covers the entire peripheral edge of the capturing unit 6; however, the structure of the holding unit 7 is not limited to a tubular structure. The holding unit 7 is supported by the support unit 2 at a downstream location in the direction in which the air flows. Here, the “supported” state includes not only the state of being fixed to the support unit 2 with a fastener or the like but also the state of being supported in contact with the support unit 2. In the latter case, the holding unit 7 is fixed to an object other than the support unit 2, for example, to a device including the fine-particle source 10.

The above-described structure in which the holding unit 7 is attached to the support unit 2 has the following effects. That is, as illustrated in FIG. 1B, heat Q of the air that passes through the capturing unit 6 is transmitted to the support unit 2 made of metal. Therefore, the temperature of the air passing through the capturing unit 6 decreases toward the downstream side of the capturing unit 6. Accordingly, even when the air passing through the capturing unit 6 contains the fine particles p in a vaporized state, the fine particles p are solidified and captured when the air passes through the micropores 6b.

It is undesirable to attach the holding unit 7 to the support unit 2 such that the holding unit 7 is supported by the support unit 2 at an upstream location in the direction in which the air flows. In such a case, the heat Q of the air passing through the capturing unit 6 is transmitted to the support unit 2 from the upstream side of the capturing unit 6. Therefore, the temperature of the air cannot be easily reduced toward the downstream side of the capturing unit 6.

A typical or exemplary form of the fine-particle-capturing device according to the present exemplary embodiment will now be described.

In one example of the capturing unit 6, the plate-shaped member 6a may have the micropores 6b having a honey-comb structure. When the micropores 6b have a honey-comb structure as in this example, high-strength, high-opening-ratio holes may be formed; however, the micropores 6b are not limited to this. In addition, in one example of the capturing unit 6, the plate-shaped member 6a may be made of aluminum. In this case, the plate-shaped member 6a may be made of a light, anti-corrosive material in which the micropores 6b may be easily formed. In addition, in one example of the capturing unit 6, the plate-shaped member 6a may have a thickness in the range of 5 to 20 mm. When the thickness is less than 5 mm, the fine particles p in a vaporized state may pass through the plate-shaped member 6a as is. When the thickness is greater than 20 mm, an excessive pressure drop may occur.

In addition, in one example of the capturing unit 6, the plate-shaped member 6a may have an area greater than an area of the exhaust opening 4. In this example, the capturing unit 6 has a large capturing region for capturing the fine particles p. In this case, the holding unit 7 may be formed as in the following examples. In one example, a cross-sectional area of the cavity 8 in a direction parallel to the exhaust opening 4 may be greater than the area of the exhaust opening 4. In another example, a length of the cavity 8 in the direction in which air passes through the capturing unit 6 is greater than a thickness of the capturing unit 6.

In addition, in one example, the holding unit 7 may include a tubular member 7a that surrounds the capturing unit 6 and the cavity 8. In this example, the tubular member 7a may have a capturing opening 7b at an inlet adjacent to the capturing unit 6. The tubular member 7a may have a communication opening 7c at an outlet that communicates with the exhaust opening 4. In this example, the tubular member 7a may be formed of a single part or plural parts.

In this example, the holding unit 7 may include a supported portion 7d supported by the support unit 2 at an edge of the communication opening 7c in the tubular member 7a. In this case, the supported portion 7d of the holding unit 7 is supported by the support unit 2 at a downstream location in the direction in which air passes through the capturing unit 6. In addition, to facilitate the attachment of the capturing unit 6 to the holding unit 7, the holding unit 7 may be formed as follows. That is, the communication opening 7c in the tubular member 7a of the holding unit 7 may have a size such that the capturing unit 6 is insertable into the communication opening 7c. The capturing unit 6 may be inserted into the communication opening 7c, moved along the cavity 8, and then held near an edge of the capturing opening 7b.

An air flow passage in the tubular member 7a may be selected as appropriate in accordance with the positional relationship between the fine-particle source 10 and the exhaust opening 4. A typical example of the tubular member 7a causes the air that has passed through the capturing unit 6 to flow to the exhaust opening 4 through a linear flow passage. Another typical example of the tubular member 7a causes the air that has passed through the capturing unit 6 to flow to the exhaust opening 4 through a bent flow passage.

In a typical example of the capturing unit 6, the micropores 6b are formed to extend in a thickness direction of the plate-shaped member 6a. However, the structure of the capturing unit 6 is not limited to this. For example, when the tubular member 7a has a bent flow passage, the capturing unit 6 may be structured as follows. That is, the micropores 6b in the capturing unit 6 may be formed to extend in a direction at an angle relative to the thickness direction of the plate-shaped member 6a. In this case, the capturing unit 6 may be disposed such that the micropores 6b extend toward the exhaust opening 4.

The present disclosure will now be described in further detail based on exemplary embodiments illustrated in the accompanying drawings.

### First Exemplary Embodiment

### Overall Structure of Image Forming System

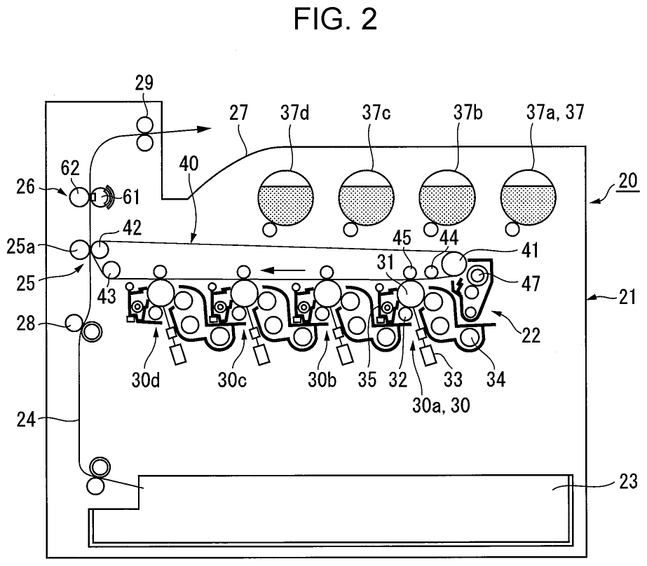

FIG. 2 illustrates the overall structure of an image forming system as an example of a powder-processing system according to a first exemplary embodiment.

In FIG. 2, an image forming system 20 includes an image forming engine 22 for forming, for example, plural color component images in a system housing 21. A medium supplying device 23 (one-stage structure is illustrated in this example) for supplying media, such as paper sheets, is disposed below the image forming engine 22. In this example, a medium supplied from the medium supplying device 23 is transported along a medium transport path 24 extending substantially vertically. The images formed by the image forming engine 22 are transferred to the medium by a transfer device 25. After that, the images transferred to the medium are fixed by a fixing device 26. The medium to which the images are fixed is output, for example, to a medium receiver 27 provided at the top of the system housing 21.

### Image Forming Engine

In this example, the image forming engine 22 includes plural image forming sections (for example, four image forming sections) 30 that form respective color component images. Each of the image forming sections 30 (specifically, 30a to 30d) includes an electrophotographic system. In this example, four color component images of respective colors, which are yellow (Y), magenta (M), cyan (C), and black (K), are formed.

The image forming engine 22 also includes an intermediate transfer body 40 that holds the color component images formed by the image forming sections 30 and transferred to the intermediate transfer body 40 in a first transfer process. In this example, the color component images transferred to the intermediate transfer body 40 in the first transfer process are simultaneously transferred to the medium by the transfer device 25 (second transfer process).

In this example, each of the image forming sections 30 (30a to 30d) includes, for example, a drum-shaped photoconductor 31. A charging device 32, a latent-image-forming device 33, a developing device 34, and a cleaning device 35 are sequentially arranged around the photoconductor 31. In this example, the charging device 32 includes, for example, a charging roller that charges the photoconductor 31. The latent-image-forming device 33 includes, for example, a light-emitting-diode (LED) array that forms an electrostatic latent image on the charged photoconductor 31. The developing device 34 develops the electrostatic latent image formed on the photoconductor 31 with toner of the corresponding color component. The cleaning device 35 removes the toner remaining on the photoconductor 31 after the corresponding color component image is transferred to the intermediate transfer body 40 in the first transfer process.

Although each image forming section 30 includes the latent-image-forming device 33 that individually forms the corresponding electrostatic latent image in this example, this does not imply any limitation. A shared laser scanner may be used to form the electrostatic latent image of each color component on the corresponding image forming section 30 with corresponding laser light. Each image forming section 30 may, of course, be provided with an individual laser scanner. Reference numeral 37 (37a to 37d) denotes toner cartridges. The toner cartridges 37 supply toners of respective color components to the developing devices 34 of the corresponding image forming sections 30.

In addition, in this example, the intermediate transfer body 40 is a belt-shaped member wrapped around plural tension rollers (four tension rollers in this example) 41 to 44. In this example, the tension roller 41, for example, serves as a driving roller that drives the intermediate transfer body 40 such that the intermediate transfer body 40 is rotatable in a predetermined direction. The tension roller 43 serves as a tension-applying roller that applies an appropriate tension to the intermediate transfer body 40.

First transfer devices 45 are provided on an inner surface of the intermediate transfer body 40 to face the photoconductors 31 of the respective image forming sections 30. Each first transfer device 45 receives a predetermined transfer bias, for example, and transfers the color component image formed on the corresponding photoconductor 31 to the intermediate transfer body 40 in the first transfer process.

Reference numeral 47 denotes an intermediate-transfer-body cleaning device that removes substances (toner, paper dust, etc.) remaining on the intermediate transfer body 40.

### Transfer Device

In this example, the transfer device 25 includes a transfer roller 25a that is in contact with an outer surface of the intermediate transfer body 40 in a rotatably drivable manner. The transfer roller 25a is disposed such that, for example, the tension roller 42 of the intermediate transfer body 40 serves as a counter electrode. An appropriate transfer electric field is formed between the transfer roller 25a and the counter electrode (tension roller 42). As a result, the images held by the intermediate transfer body 40 are simultaneously transferred to the medium.

Although the transfer device 25 includes the transfer roller 25a in this example, the transfer device 25 is not limited to this. For example, a non-contact transfer device using corona discharge or a transfer belt module including a transfer belt may be used as long as a transfer electric field may be formed.

### Medium Transport System

Alignment rollers 28 for aligning the medium to be fed to the transfer device 25 are provided adjacent to the entrance of the transfer device 25 on the medium transport path 24. Output rollers 29 are provided immediately in front of the medium receiver 27 on the medium transport path 24. Transport rollers (not illustrated) are arranged as appropriate along the medium transport path 24.

### Overall Structure of Fixing Device

In the present exemplary embodiment, the fixing device 26 includes a fixing housing 60 in which a heating rotating body 61 and a pressing rotating body 62 are held. The fixing device 26 transports the medium while nipping the medium in a contact region CN between the heating rotating body 61 and the pressing rotating body 62. Thus, the fixing device 26 fixes the unfixed images that have been transferred to the medium to the medium by applying heat and pressure in the contact region CN.

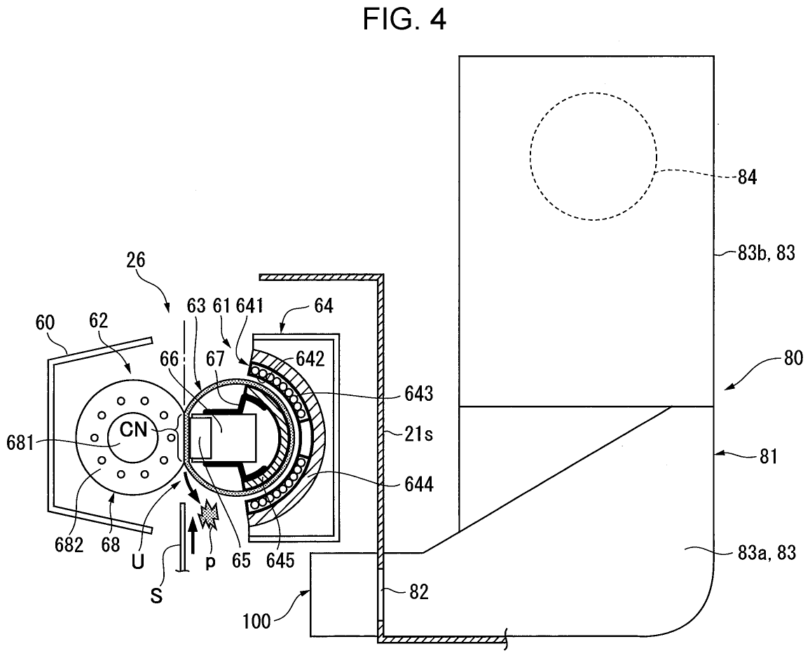

In this example, as illustrated in FIG. 4, the heating rotating body 61 uses, for example, an induction heating method. The heating rotating body 61 includes a thermal fixing belt 63, a magnetic-field generator 64, and a pressing pad 65. The thermal fixing belt 63 is a belt member including a heating layer that generates heat in response to a magnetic field. The magnetic-field generator 64 is disposed to face an outer peripheral surface of the thermal fixing belt 63 with a predetermined gap therebetween. The magnetic-field generator 64 generates a magnetic field for causing the thermal fixing belt 63 to generate heat. In addition, the pressing pad 65 is disposed on the inner surface of the thermal fixing belt 63 and presses the thermal fixing belt 63 against the pressing rotating body 62.

The pressing rotating body 62 serves as a pressure fixing roller 68 that presses the thermal fixing belt 63 at a location at which the pressing rotating body 62 faces the pressing pad 65.

### Thermal Fixing Belt and Pressure Fixing Roller

In this example, the thermal fixing belt 63 is a belt member having a multilayer structure including, for example, a base layer, a conductive layer made of a non-magnetic metal, an elastic layer, and a surface layer. In this example, the conductive layer serves as a heating layer.

The pressure fixing roller 68 includes a rotating shaft 681 and a roller body 682 formed of an elastic body provided around the rotating shaft 681. The pressure fixing roller 68 may, of course, be provided with a heating source as necessary.

### Magnetic-Field Generator

In this example, the magnetic-field generator 64 includes a mount 641 that surrounds substantially one-half of the circumference of the outer peripheral surface of the thermal fixing belt 63 at a side opposite to the side adjacent to the pressure fixing roller 68. The mount 641 extends in a width direction of the thermal fixing belt 63 and has an arc-shaped cross-section. The mount 641 has a coil-receiving section 642 that extends therearound along the width direction of the thermal fixing belt 63. This coil-receiving section 642 holds an excitation coil 643 having a winding structure.

Furthermore, in this example, a magnetic-field-holding member 644 is disposed outside the magnetic-field generator 64, and a magnetic-field-holding member 645 is disposed inside the thermal fixing belt 63 that faces the magnetic-field generator 64. The magnetic-field-holding members 644 and 645 are made of a magnetic material (for example, ferrite). These magnetic-field-holding members 644 and 645 have a substantially arc-shaped cross-section along the shape of the mount 641. Thus, the magnetic-field-holding members 644 and 645 disposed outside and inside the thermal fixing belt 63 sandwich the thermal fixing belt 63 therebetween and hold the magnetic field generated by the excitation coil 643. As a result, an appropriate magnetic path is formed in the thermal fixing belt 63 to increase the heating efficiency by induction.

### Structure Around Pressing Pad

A pad support member 66 that supports the pressing pad 65 is disposed inside the thermal fixing belt 63 that faces the pressure fixing roller 68. The pad support member 66 is provided with a support bracket 67. The support bracket 67 supports the magnetic-field-holding member 645 disposed inside the thermal fixing belt 63.

### Attachment Structure and Driving Method of Fixing Device

In this example, the image forming system 20 includes a user operation unit (not illustrated) on the front of the system housing 21. Therefore, the system housing 21 has a front frame 21f on the front at which the user operates the user operation unit and a rear frame 21r on the back.

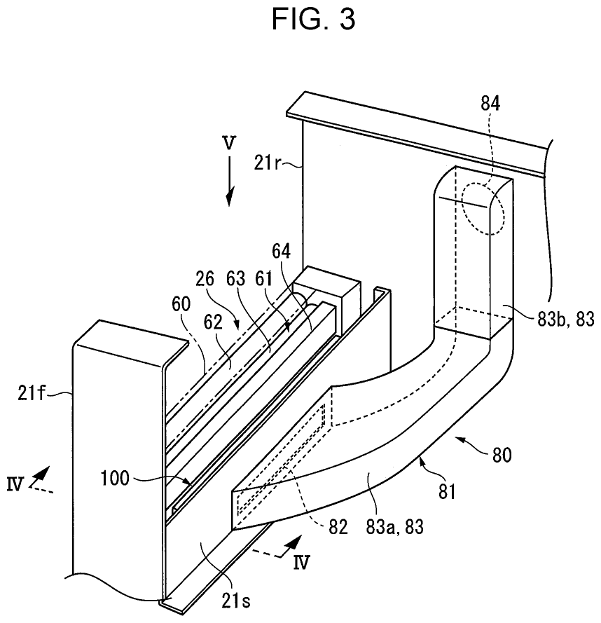

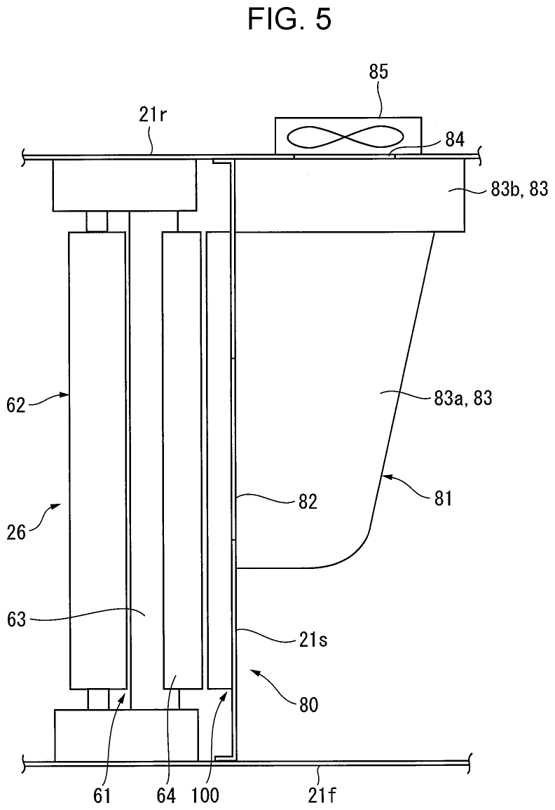

In this example, as illustrated in FIGS. 3 and 5, the fixing device 26 is fixed to the system housing 21 at both ends of the fixing housing 60 in a longitudinal direction thereof. The longitudinal direction of the fixing housing 60 corresponds to a width direction of the medium S that crosses a direction in which the medium S is transported. The fixing housing 60 extends between and attached to the front frame 21f and the rear frame 21r at both ends thereof in the longitudinal direction. The front frame 21f and the rear frame 21r are, for example, plate members made of metal, such as stainless steel.

In addition, in this example, as illustrated in FIG. 4, the fixing device 26 is structured such that the pressure fixing roller 68 serving as the pressing rotating body 62 is driven. Specifically, a driving mechanism (not illustrated) is connected to a back end portion of the rotating shaft 681 of the pressure fixing roller 68. Therefore, in this example, the thermal fixing belt 63 of the heating rotating body 61 is rotated by the rotation of the pressure fixing roller 68 in the contact region CN.

### Exhaust Structure Around Fixing Device

### Necessity to Discharge Gas Around Fixing Device

In this example, the fixing device 26 fixes the toner images on the medium S by applying heat and pressure in the contact region CN between the heating rotating body 61 and the pressing rotating body 62. At this time, the ambient temperature increases in the fixing housing 60 of the fixing device 26 due to the fixing process.

A temperature increase in the system housing 21 is undesirable. For example, an increase in the ambient temperature around the toner cartridges 37 may lead to melting of the toner.

Accordingly, in this example, as illustrated in FIGS. 3 to 5, a partition frame 21s is provided between the fixing device 26 and the toner cartridges 37. The partition frame 21s is, for example, a plate member made of metal, such as stainless steel, and is disposed near the fixing device 26. The partition frame 21s extends between the front frame 21f and the rear frame 21r and is fixed with fasteners or the like.

The partition frame 21s serves as a heat shield that prevents the air around the fixing device 26 from flowing into the region around the toner cartridges 37.

However, it is undesirable for the fixing device 26 to be constantly surrounded by high-temperature air. Accordingly, to maintain the ambient temperature in the fixing housing 60 at an appropriate level, the high-temperature air around the fixing device 26 is to be discharged.

### Points to be Considered Regarding Exhaust Structure

When establishing an exhaust structure around the fixing device 26, the following points are to be considered.

In this example, the developing device 34 of each image forming section 30 contains the toner of the respective color component. This toner often contains hydrocarbon-based wax, such as paraffin wax or polyethylene wax. This type of wax is added to the toner to facilitate the separation of the toner from the heating rotating body 61 and the pressing rotating body 62.

Therefore, this type of wax liquefies due to heat and pressure applied when the toner images on the medium S pass through the contact region CN in the fixing device 26. At this time, the wax seeps out from the inside of the toner to the surface and is partially vaporized and released into the air. The vaporized wax is carried by the surrounding airflow and floats in the ambient space in the form of ultra-fine particles (including fine particles p) with a size of 100 nm or less. When the air around the fixing device 26 is discharged out of the image forming system 20 including no capturing device, the vaporized wax is released out of the image forming system 20.

Thus, in this example, the fixing device 26 tends to serve as a device including a fine-particle source U. In particular, as illustrated in FIG. 4, a region adjacent to the entrance of the contact region CN between the heating rotating body 61 and the pressing rotating body 62 from which the medium S enters the contact region CN is likely to serve as the fine-particle source U.

Although the fixing device 26 using the induction heating method is described in this example, a similar phenomenon also occurs in fixing devices using other thermal fixing methods, for example, a fixing device that has a heater inside a thermal fixing roller and requires no magnetic-field generator used in the induction heating method.

Thus, a fixing device to which a capturing device 80 described below may be applied is not limited to the fixing device 26 using the induction heating method, and may be various fixing devices using other thermal fixing methods. This applies not only to the first exemplary embodiment but also to second to fourth exemplary embodiments and modifications described below.

### Capturing Device

### Basic Structure of Capturing Device

In this example, an exhaust structure provided around the fixing device 26 includes a capturing device 80 that captures fine particles from the fine-particle source U. In particular, in this example, the capturing device 80 captures ultra-fine particles of vaporized wax or the like generated by the fine-particle source U and having a size of 100 nm or less.

In this example, as illustrated in FIGS. 3 to 5, the capturing device 80 uses the partition frame 21s as a support unit made of metal. The capturing device 80 also includes an exhaust mechanism 81 serving as an exhaust unit that discharges the air around the fixing device 26 and a capturing component 100 attached to the exhaust mechanism 81 to capture the fine particles.

### Exhaust Mechanism

In this example, the exhaust mechanism 81 has a rectangular exhaust opening 82 formed in the partition frame 21s and extending in a front-rear direction. An exhaust duct 83 that communicates with the exhaust opening 82 is provided in a region on a side of the partition frame 21s opposite to the side adjacent to the fixing device 26. The exhaust duct 83 is made of a synthetic resin, such as ABS resin, and includes a first duct member 83a and a second duct member 83b. One end of the first duct member 83a is connected to the exhaust opening 82 to surround the exhaust opening 82. The first duct member 83a extends along the partition frame 21s toward the rear frame 21r. The second duct member 83b extends along the rear frame 21r in an up-down direction. A lower end of second duct member 83b is connected to an end of the first duct member 83a opposite to the end connected to the exhaust opening 82. The rear frame 21r has a ventilation outlet 84 that communicates with the outside at a position near an upper end of the second duct member 83b. A suction fan 85 that draws out the air in the exhaust duct 83 is provided on the rear frame 21r at a position facing the ventilation outlet 84. The amount of airflow caused by the suction fan 85 is determined to maintain the efficiency of capturing the fine particles p with the capturing component 100 at an appropriate level. The amount of airflow may be determined in consideration of, for example, the ventilation resistance of the capturing component 100, the temperature increase around the fixing device 26, and the operating noise.

### Capturing Component

### Basic Structure of Capturing Component

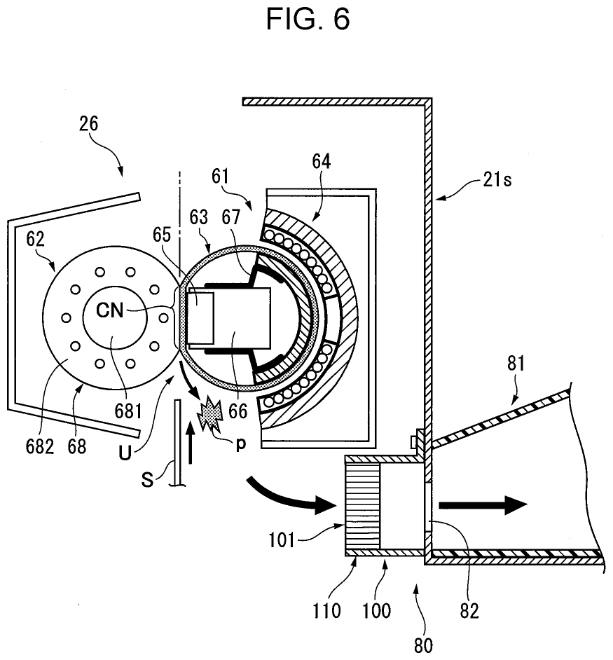

In this example, as illustrated in FIGS. 6 to 8, the capturing component 100 is disposed in a region on a side of the partition frame 21s adjacent to the fixing device 26. The capturing component 100 is disposed to cover the exhaust opening 82 of the exhaust mechanism 81. The capturing component 100 includes a filter 101 made of metal as a capturing unit and a holder 110 made of metal as a holding unit that holds the filter 101.

### Filter

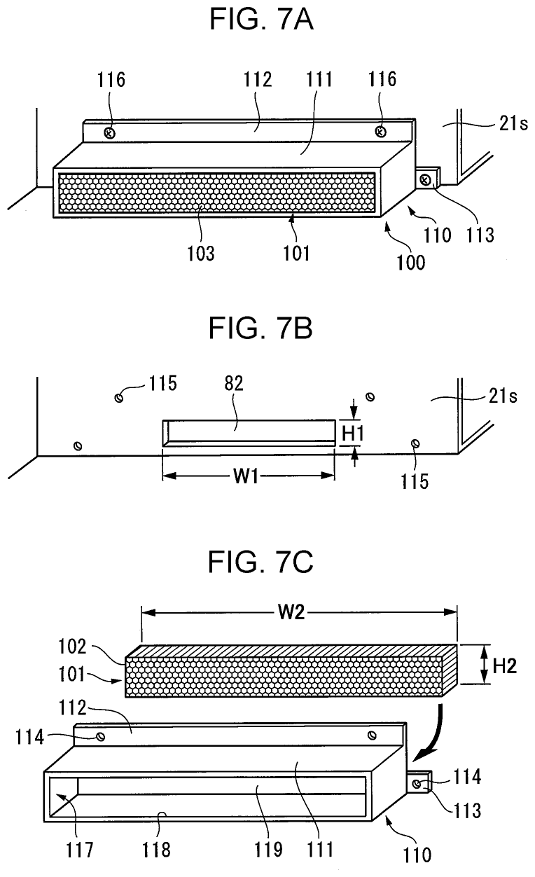

In this example, the filter 101 may include a plate-shaped member 102 made of metal. The plate-shaped member 102 has a rectangular shape larger than the exhaust opening 82. As illustrated in FIGS. 7B and 7C, assume that the exhaust opening 82 has a height and a width of H1 and W1, respectively, and that the plate-shaped member 102 has a height and a width of H2 and W2, respectively. In this example, H2>H1 and W2>W1 may be satisfied. For example, H2=2×H1 and W2=2×W1 may be satisfied.

The plate-shaped member 102 has micropores 103 extending therethrough in the thickness direction. The micropores 103 have a polygonal cross-section and are regularly arranged.

In particular, in this example, an aluminum plate, for example, is used as the plate-shaped member 102. The aluminum plate is selected as the plate-shaped member 102 because the micropores 103, for example, may be easily formed therein and high corrosion resistance may be obtained.

A thickness D of the plate-shaped member 102 is set as appropriate in the range of 5 to 20 mm. In addition, the micropores 103 have a honey-comb structure with a regular hexagonal cross-section. The number of micropores 103 may be determined as appropriate in the range of, for example, 600 to 1800 per square inch.

When the thickness D of the plate-shaped member 102 is less than 5 mm, the effect of regulating the flow of air that passes through the micropores 103 is reduced. When the thickness D exceeds 20 mm, the pressure drop in the air that passes through the micropores 103 cannot be easily reduced.

When the number of micropores 103 is less than 600, the surface area is reduced, and the ultra-fine particles cannot be effectively captured. In addition, the effect of regulating the flow of air that passes through the micropores 103 is reduced. When the number of micropores 103 exceeds 1800, the pressure drop in the air that passes through the micropores 103 cannot be easily reduced.

When the micropores 103 having a honey-comb structure are compared with micropores having a structure other than a honey-comb structure, such as micropores that are round holes, the differences are as follows. That is, the micropores 103 having a honey-comb structure have a greater partition strength than the micropores that are round holes. Therefore, a thickness t of partition walls 104 that separate the micropores 103 from each other may be reduced. As a result, the micropores 103 having a honey-comb structure may have a larger cross-sectional area, and the opening ratio of the micropores 103 may be increased.

### Holder

### Basic Structure of Holder

In this example, as illustrated in FIGS. 4 and 7A, the holder 110 is attached to a surface of the partition frame 21s that is adjacent to the fixing device 26.

As illustrated in FIG. 7A to 7C, the holder 110 includes a holder frame member 111 serving as a tubular member that holds the filter 101. The holder frame member 111 includes attachment tabs 112 and 113 serving as supported portions used to attach the holder frame member 111 to the partition frame 21s. The attachment tab 112 protrudes in the shape of a flange from an upper edge of one opening of the holder frame member 111. The attachment tabs 113 protrude in the shape of a flange from lower portions of side edges of the opening of the holder frame member 111 in the longitudinal direction. In FIGS. 7A to 7C, reference numeral 114 denotes attachment holes formed in the attachment tabs 112 and 113, reference numeral 115 denotes attachment holes formed in the partition frame 21s and corresponding to the attachment holes 114, and reference numeral 116 denotes attachment fasteners.

### Example of Structure of Holder Frame Member

In this example, the holder frame member 111 is, for example, a substantially rectangular frame-shaped member formed of a plate member made of metal, such as stainless steel. The holder frame member 111 is disposed such that a passage space 117 having a rectangular cross-section that communicates with the exhaust opening 82 in the partition frame 21s is formed therein. Therefore, the passage space 117 in the holder frame member 111 has a capturing opening 118 at an inlet separated from the exhaust opening 82. The passage space 117 in the holder frame member 111 also has a communication opening 119 at an outlet that communicates with the exhaust opening 82.

The cross-sectional area of the passage space 117 in the holder frame member 111 is equivalent to or somewhat greater than the cross-sectional area of the plate-shaped member 102 of the filter 101. The passage space 117 in the holder frame member 111 has a length L that is at least greater than the thickness D of the filter 101. In this example, the length L of the passage space 117 in the holder frame member 111 is greater than twice the thickness D of the filter 101.

### Positional Relationship Between Holder and Filter

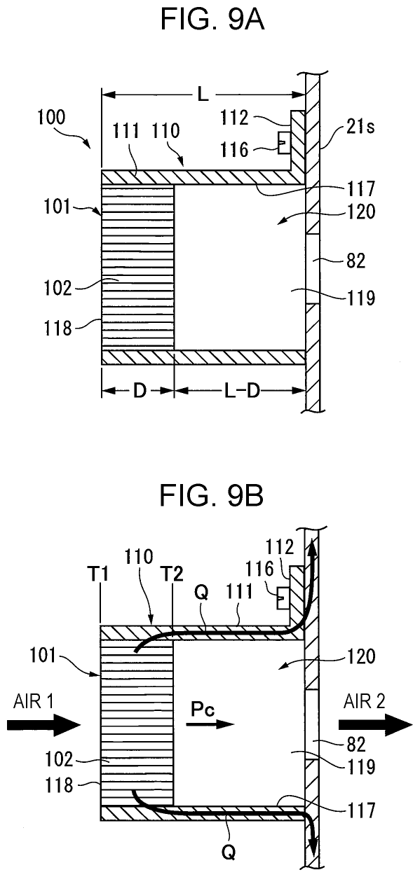

FIG. 9A illustrates the positional relationship between the holder 110 and the filter 101 in this example.

In FIG. 9A, the filter 101 is disposed in the passage space 117 in the holder frame member 111 at a location separated from the exhaust opening 82. In particular, in this example, the filter 101 is disposed to extend along the capturing opening 118 of the passage space 117 in the holder frame member 111. Thus, the holder frame member 111 holds the filter 101 such that a cavity 120 is formed between the filter 101 and the exhaust opening 82.

In this state, the cross-sectional area of the cavity 120 in a direction parallel to the exhaust opening 82 is greater than the area of the exhaust opening 82. In addition, the length (L-D) of the cavity 120 in a thickness direction of the filter 101 is greater than the thickness D of the filter 101.

### Method for Attaching Capturing Component

In this example, the filter 101 may be attached to the holder 110 as follows. That is, as illustrated in FIG. 7C, the filter 101 is inserted into the passage space 117 through the communication opening 119 in the holder frame member 111. Then, the filter 101 inserted through the communication opening 119 is moved along the passage space 117 (cavity 120) in the holder frame member 111. After that, the filter 101 is held at a position at which the filter 101 extends along the capturing opening 118 of the passage space 117 in the holder frame member 111.

The filter 101 may, for example, be held by the following method. That is, an elastic blocking member may be attached to the peripheral edge of the plate-shaped member 102 in advance, and the filter 101 may be held by a peripheral wall of the holder frame member 111 with the elastic blocking member interposed therebetween. The elastic blocking member may be, for example, an elastic sealing member, such as a urethane sealing member. Instead of using the elastic blocking member, the filter 101 may be held by applying an adhesive to the peripheral edge of the plate-shaped member 102 and bonding the plate-shaped member 102 to the holder frame member 111.

### Operation of Image Forming System

In this example, when the image forming system 20 illustrated in FIG. 2 performs an image forming process, the image forming engine 22 forms the color component images. Then, the thus-formed color component images are transferred to the medium by the transfer device 25. After that, the color component images transferred to the medium are fixed by the fixing device 26. After that, the medium to which the images are fixed is output to the medium receiver 27.

In this process, there is a risk that the fine particles p are generated by the fine-particle source U around the fixing device 26; accordingly, in this example, the capturing device 80 for the fine particles p is operated.

### Operation of Capturing Device

In this example, as illustrated in FIGS. 4 and 5, the exhaust mechanism 81 of the capturing device 80 activates the suction fan 85 to draw out the air in the exhaust duct 83. Accordingly, referring to FIG. 9A, the air around the fixing device 26 is discharged through the exhaust opening 82 in the partition frame 21s. At this time, the air around the fixing device 26 includes the fine particles p from the fine-particle source U. However, the fine particles p of this type are captured by the capturing component 100 of the capturing device 80. Therefore, the amount of fine particles p included in the air discharged through the exhaust opening 82 is reduced.

Principle of Capturing Fine Particles with Capturing Component

In this example, as illustrated in FIGS. 9A and 9B, the filter 101 is disposed to extend along the capturing opening 118 of the passage space 117 in the holder frame member 111. The holder frame member 111 is attached to the partition frame 21s using the attachment tabs 112 and 113 at a position close to the communication opening 119 of the passage space 117.

A negative pressure is generated in the exhaust opening 82 in the partition frame 21s due to the suction force applied by the suction fan 85. Therefore, a surface of the filter 101 facing the cavity 120 in the holder frame member 111 receives a suction force generated by the negative pressure. As a result, air is drawn through the micropores 103 formed in the plate-shaped member 102 of the filter 101. Therefore, in this example, the air that has passed through the filter 101 flows to the exhaust opening 82 along a linear flow passage.

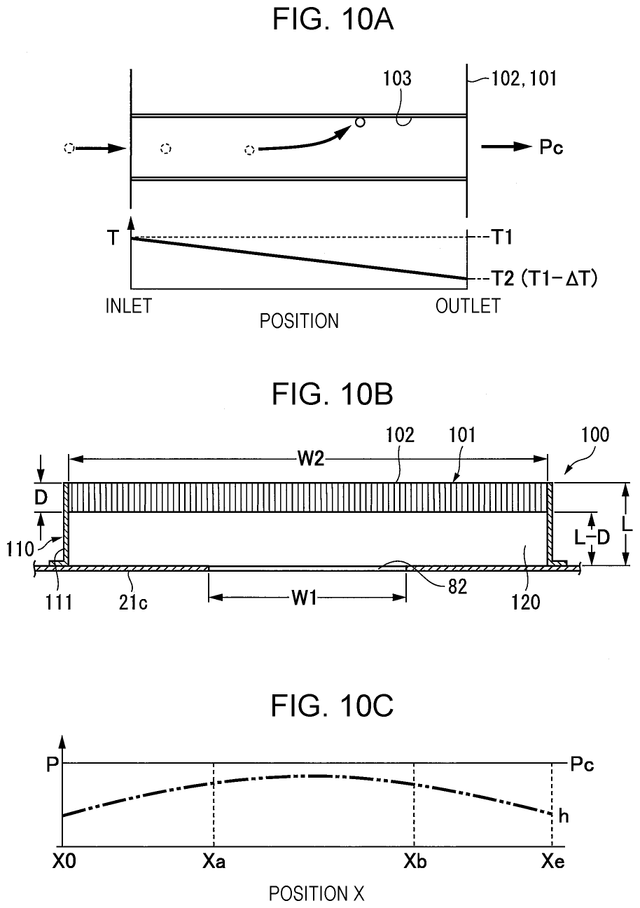

The filter 101, the holder 110, and the partition frame 21s are all made of metal. Therefore, as illustrated in FIG. 9B, the heat Q of the air passing through the filter 101 is transmitted to the partition frame 21s through the holder frame member 111. As a result, as illustrated in FIG. 10A, a temperature T of the air passing through the micropores 103 in the filter 101 decreases downstream in the direction in which the air flows. For example, when the temperature of the air at the inlet of the micropores 103 is T1 and when the temperature of the air at the outlet of the micropores 103 is T2, the temperature decreases by ΔT (T1−T2). Therefore, even when the air passing through the filter 101 includes the fine particles p in a vaporized state, the fine particles p are solidified and captured as the fine particles p pass through the micropores 103. In FIG. 10A, the fine particles p shown by the dotted lines are in a vaporized state, and the fine particle p shown by the solid line is in a solid state.

Thus, referring to FIG. 9B, the air (AIR 1) that has not yet passed through the filter 101 of the capturing component 100 includes the fine particles p in a vaporized state. However, the amount of fine particles p in a solid state and a vaporized state included in the air (AIR 2) that has passed through the filter 101, is reduced. Thus, the capturing component 100 of this example has the ability to appropriately capture the fine particles p.

In this example, the ability of the capturing component 100 to capture the fine particles p is maintained even after the image forming process is repeated. The number of repetitions of the image forming process is, for example, two million pages for A4 size paper.

Therefore, in the present exemplary embodiment, the capturing component 100 basically does not require replacement or maintenance. However, the exterior of the capturing component 100 may, of course, be subjected to cleaning or the like during maintenance.

The positional relationship between the cavity 120 in the holder frame member 111, the exhaust opening 82, and the filter 101 will now be describe with reference to FIG. 10B.

In FIG. 10B, the cross-sectional area of the cavity 120 in the holder frame member 111 in a direction parallel to the exhaust opening 82 is greater than the area of the exhaust opening 82. In addition, the length L-D of the cavity 120 in the direction in which the air flows is greater than the thickness D of the filter 101. Although the air in the cavity 120 is drawn through the exhaust opening 82 having a small cross-sectional area, the cavity 120 has a large capacity relative to the direction in which the air flows.

The operation of the above-described characteristic structure will now be described.

FIG. 10C illustrates the pressure distribution on the surface of the filter 101 adjacent to the cavity 120.

In FIG. 10C, the horizontal axis X represents the position in a crossing direction that crosses the direction in which the air flows through the cavity 120, and the vertical axis P represents the pressure applied to the surface of the filter 101. In addition, X0 and Xe are positions of both ends of the cavity 120 in the crossing direction, and Xa and Xb are the positions of both ends of the exhaust opening 82 in the cavity 120 in the longitudinal direction.

A difference in the pressure distribution on the surface of the filter 101 adjacent to the cavity 120 caused by a difference in the length L-D of the cavity 120 will now be discussed.

When the length L-D of the cavity 120 is greater than or equal to a predetermined threshold, the pressure distribution is as follows. That is, as shown by the solid line in FIG. 10C, the surface of the filter 101 receives a pressure Pc that is substantially uniform over the entire area thereof. This is probably because even when the air is drawn through the exhaust opening 82, the suction pressure is distributed in the cavity 120 as the distance from the exhaust opening 82 increases.

In contrast, when the length L-D of the cavity 120 is less than the predetermined threshold, the pressure distribution is as follows. That is, as shown by the two-dot chain line in FIG. 10C, the pressure on the surface of the filter 101 is higher in the region corresponding to the exhaust opening 82 than in other regions. This is probably because the suction pressure is not sufficiently distributed in the cavity 120 due to the short distance between the surface of the filter 101 and the exhaust opening 82.

### Comparative Example 1

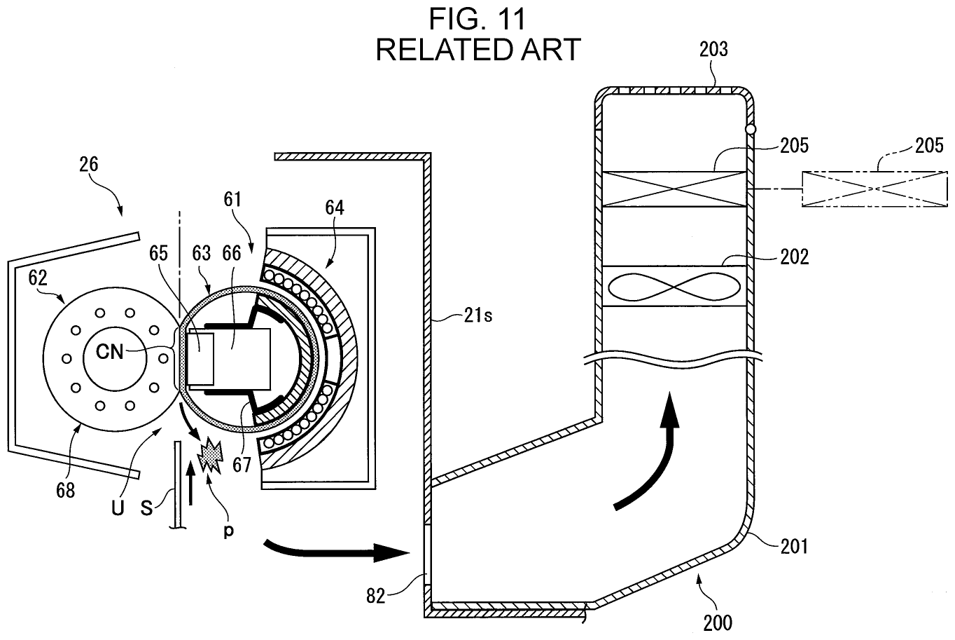

FIG. 11 illustrates an example of the structure of a capturing component included in an exhaust structure disposed near a fixing device according to a first comparative example.

In FIG. 11, an exhaust mechanism 200 is disposed around the fixing device 26. This exhaust mechanism 200 includes, for example, an exhaust duct 201 that communicates with the exhaust opening 82 in the partition frame 21s. A suction fan 202 for drawing air is disposed in the exhaust duct 201.

In this example, the exhaust duct 201 has a ventilation outlet provided with a removable louver 203. An insertable/extractable filter unit 205 is removably provided in the exhaust duct 201 at a location near the louver 203. The filter unit 205 includes a frame and a nonwoven filter held by the frame.

In this example, the fine particles p generated by the fine-particle source U around the fixing device 26 are basically captured by the filter unit 205.

Therefore, in this example, to maintain the effectiveness in capturing the fine particles p, the louver 203 needs to be removed and the filter unit 205 needs to be replaced. In addition, when high-temperature air is discharged as is, the fine particles p in a vaporized state may flow through the nonwoven filter in the filter unit 205 and be discharged.

### Second Exemplary Embodiment

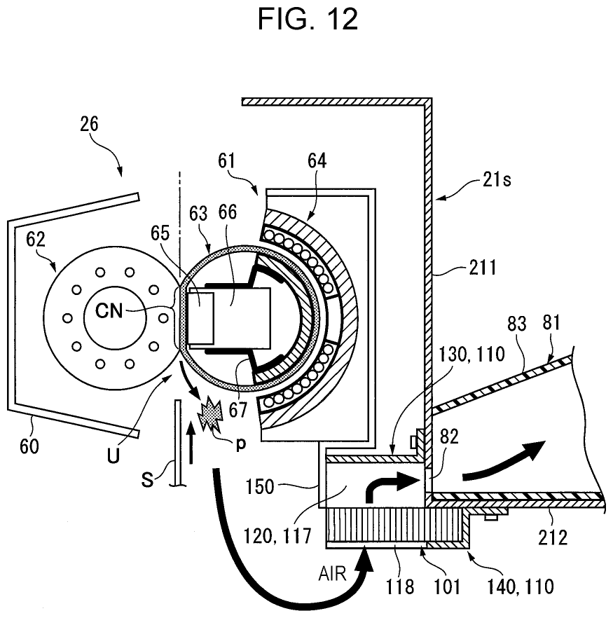

FIG. 12 illustrates an example of the structure of a capturing component included in an exhaust structure around a fixing device according to a second exemplary embodiment.

In FIG. 12, the basic structure of a capturing device 80 for capturing the fine particles p is similar to that of the first exemplary embodiment, and an exhaust mechanism 81 is formed by using the partition frame 21s. However, a capturing component 100 used in this example differs from that in the first exemplary embodiment. Components similar to those in the first exemplary embodiment are denoted by the same reference numerals as those in the first exemplary embodiment, and detailed description thereof is omitted herein.

### Filter

In FIG. 12, a filter 101 has a structure similar to that in the first exemplary embodiment (a plate-shaped member 102, micropores 103, partition walls 104, and an elastic blocking member 105).

In this example, unlike the first exemplary embodiment, the filter 101 extends horizontally at a location below an exhaust opening 82 in the partition frame 21s.

In addition, in this example, the partition frame 21s includes a vertical frame element extending vertically and a horizontal frame element extending horizontally from the lower end of the vertical frame element. Therefore, the filter 101 is disposed below the horizontal frame element of the partition frame 21s so that the filter 101 does not interfere with the horizontal frame element.

### Holder

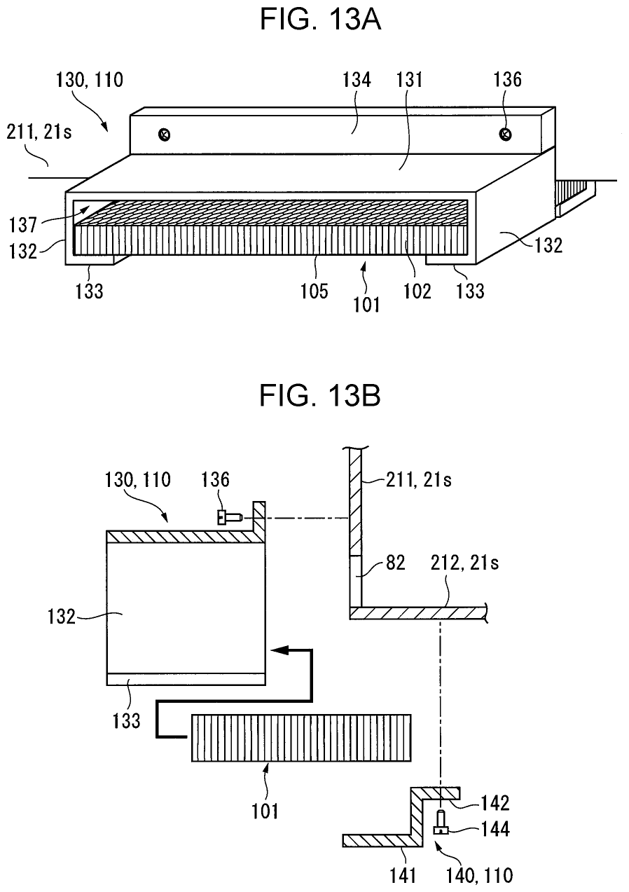

In this example, the holder 110 holds the above-described filter 101 in a horizontal orientation. Referring to FIGS. 13A to 15C, in this example, the holder 110 includes two parts (a first holder frame member 130 and a second holder frame member 140).

### First Holder Frame Member

The first holder frame member 130 is attached to a vertical frame element 211 of the partition frame 21s.

In this example, the first holder frame member 130 includes a rectangular base member 131 and a pair of side walls 132 projecting downward from both sides of the base member 131. A pair of holding tabs 133 is provided at the lower ends of the side walls 132 such that the holding tabs 133 slightly project toward each other in a horizontal direction.

In addition, an attachment tab 134, which serves as a supported portion, projects upward from one side edge of the base member 131 in a short-side direction. The base member 131, the side walls 132, and the holding tabs 133 may be formed by bending a single rectangular plate member made of metal. The attachment tab 134 is formed as a separate member, but may be formed integrally with the base member 131 by bending. Reference numeral 135 denotes attachment holes formed in the attachment tab 134, and reference numeral 136 denotes attachment fasteners.

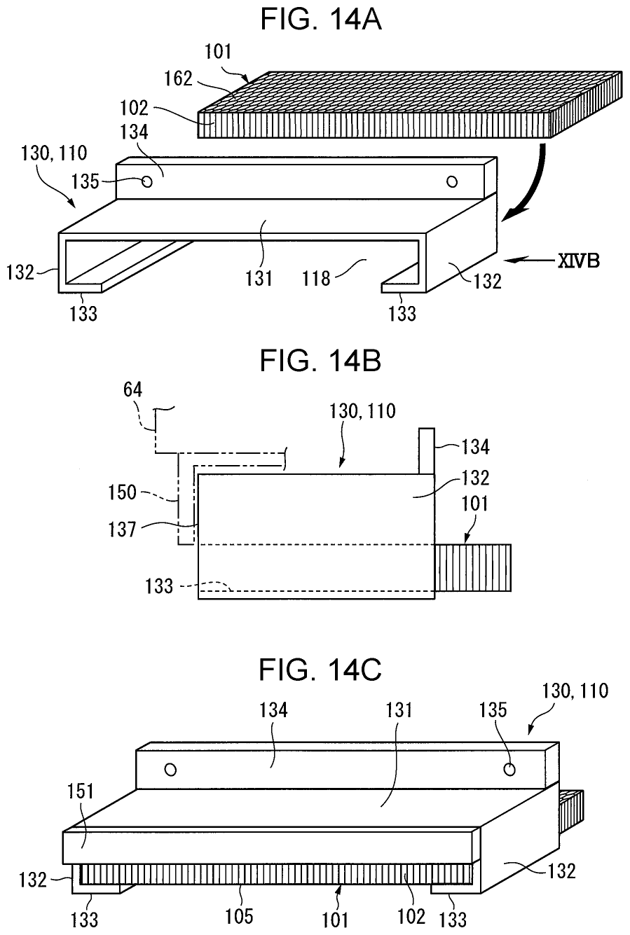

In this example, the dimension of the side walls 132 in the up-down direction is greater than the thickness of the filter 101. In addition, the dimension of the base member 131 in the short-side direction is less than the dimension of the filter 101 in the short-side direction (see FIGS. 14A and 14B).

In addition, in this example, both side portions of the filter 101 in the long-side direction are placed on and held by the pair of holding tabs 133 of the first holder frame member 130. Therefore, in this example, the opening between the pair of holding tabs 133 of the first holder frame member 130 serves as a capturing opening 118. A portion of a passage space 117 surrounded by the first holder frame member 130 and the filter 101 that faces the exhaust opening 82 serves as a communication opening 119. The communication opening 119 has an area is greater than the area of the exhaust opening 82.

In addition, the passage space 117 surrounded by the first holder frame member 130 and the filter 101 is exposed toward the fixing device 26. In other words, the first holder frame member 130 has an opening 137 that allows entrance into the passage space 117 without passing through the filter 101.

In this example, the first holder frame member 130 is structured such that the above-described opening 137 is covered with a portion of an outer structure of the fixing device 26. This will be described in detail below.

### Second Holder Frame Member

As illustrated in FIG. 13B, the second holder frame member 140 is attached to the horizontal frame element 212 of the partition frame 21s.

In this example, the second holder frame member 140 holds a portion of the filter 101 that is not held by the first holder frame member 130. Unlike the first holder frame member 130, the second holder frame member 140 does not define the passage space 117.

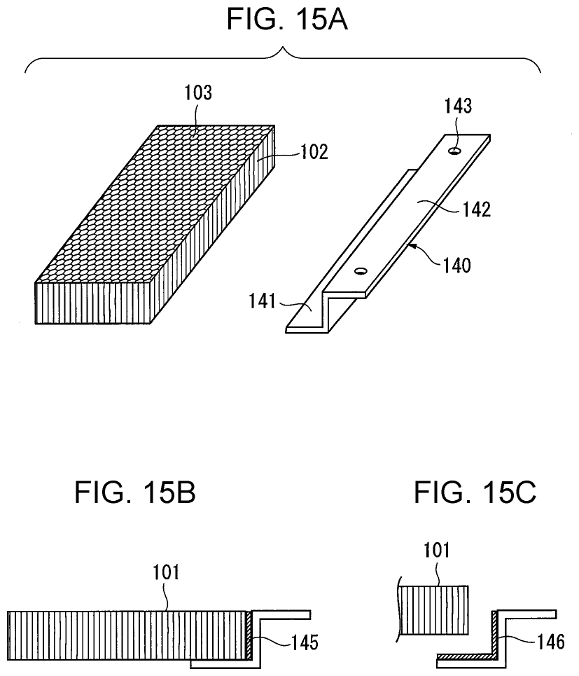

In this example, as illustrated in FIG. 15A, the second holder frame member 140 includes a holding bracket 141 having an L-shaped cross-section. An attachment tab 142, which serves as a supported portion, extends substantially horizontally along the upper edge of the holding bracket 141. The holding bracket 141 and the attachment tab 142 may, for example, be integrally formed by bending a single rectangular plate member made of metal. Alternatively, the attachment tab 142 may be attached to the holding bracket 141.

Reference numeral 143 denotes attachment holes formed in the attachment tab 142, and reference numeral 144 denotes attachment fasteners.

### Assembly and Attachment of Capturing Component

In this example, the filter 101 may be attached to the holder 110 as follows. That is, as illustrated in FIGS. 14A and 14B, the filter 101 is inserted through the communication opening 119 of the first holder frame member 130. Then, the filter 101 is moved along the pair of holding tabs 133 of the first holder frame member 130. After that, the filter 101 is held at a position at which the filter 101 extends along the opening 137 at the front of the first holder frame member 130.

In this example, the elastic blocking member 105 is provided along the peripheral edge of the filter 101. Therefore, the space between each side wall 132 of the first holder frame member 130 and the filter 101 is appropriately sealed.

FIG. 14B illustrates the state in which the filter 101 is held by the first holder frame member 130. The dimension of the filter 101 in the short-side direction is greater than the dimension of the first holder frame member 130 in the short-side direction. Therefore, a portion of the filter 101 projects from the first holder frame member 130.

The portion of the filter 101 projecting from the first holder frame member 130 is held by the second holder frame member 140. Specifically, the portion of the filter 101 is placed on and held by a horizontal portion of the holding bracket 141 of the second holder frame member 140 (see FIG. 15A).

As illustrated in FIG. 15B, the filter 101 may be fixed to the second holder frame member 140 at one side of the peripheral edge of the filter 101. The filter 101 may be fixed by a fixing unit 145, such as double-sided tape, provided on an upright portion of the holding bracket 141 of the second holder frame member 140.

In addition, in this example, the elastic blocking member 105 is provided along the peripheral edge of the filter 101. Therefore, the contact portion between the filter 101 and the second holder frame member 140 (upright portion of the holding bracket 141) is appropriately sealed. Another sealed structure may be formed as illustrated in FIG. 15C. For example, an elastic blocking member 146 may be provided in advance on contact surfaces of the second holder frame member 140 (holding bracket 141) and the filter 101.

The capturing component 100 may be attached to the partition frame 21s as illustrated in FIG. 13B.

Referring to FIG. 13B, the first holder frame member 130 and the second holder frame member 140 are arranged to hold the filter 101. After that, the first holder frame member 130 is fixed to the vertical frame element 211 of the partition frame 21s. Then, the second holder frame member 140 is fixed to the horizontal frame element 212 of the partition frame 21s.

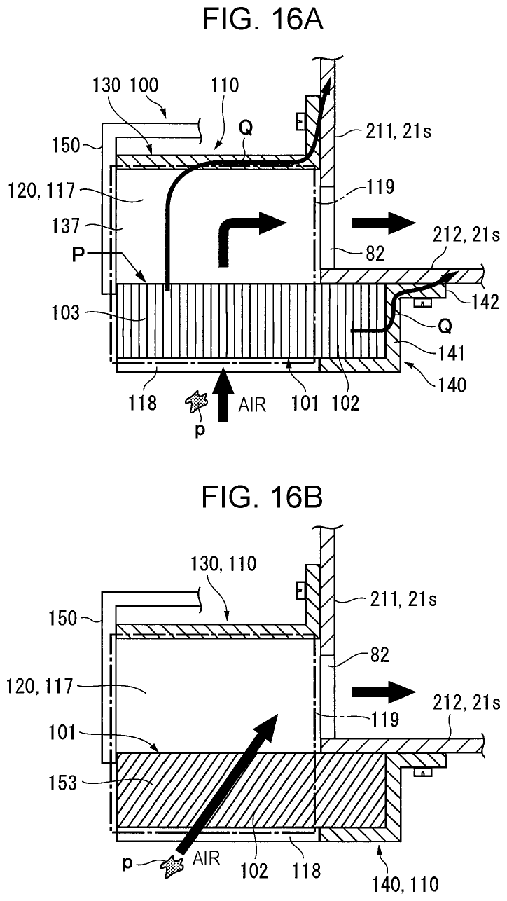

In this state, the filter 101 is held by the holder 110 as illustrated in FIGS. 13A and 16A.

The filter 101 is disposed below the horizontal frame element 212 of the partition frame 21s. In this example, the peripheral edge of the filter 101 is covered by the elastic blocking member 105. Therefore, the space between each side wall 132 of the first holder frame member 130 and the peripheral edge of the filter 101 is sealed by the elastic blocking member 105. A portion of the peripheral edge of the filter 101 that is adjacent to the opening 137 in the first holder frame member 130 is also covered by the elastic blocking member 105.

In this state, the passage space 117 in the first holder frame member 130 between the filter 101 and the exhaust opening 82 has the opening 137. Therefore, the passage space 117 in the first holder frame member 130 between the filter 101 and the exhaust opening 82 does not constitute a cavity 120 having a sealed structure. In this example, an existing component disposed around the fixing device 26 is used as a blocking member 150 for the opening 137 in the first holder frame member 130. The blocking member 150 may be, for example, an outer portion of the magnetic-field generator 64 or a portion of the fixing housing 60. The blocking member 150 may be disposed to prevent air from directly flowing into the passage space 117 through the opening 137 without passing through the filter 101. The blocking member 150 is preferably disposed in close contact with the elastic blocking member 105 on the peripheral edge of the filter 101 adjacent to the opening 137.

Thus, the first holder frame member 130 and the blocking member 150 both contribute to maintain the cavity 120 sealed. Therefore, in this example, the blocking member 150 also serves as a component of a holding unit as the holder 110.

The second holder frame member 140 holds the filter 101 as illustrated in FIG. 16A. Specifically, the filter 101 is sandwiched between the second holder frame member 140 (holding bracket 141) and the horizontal frame element 212. In the region around the second holder frame member 140, the elastic blocking member 105 on the peripheral edge of the filter 101 seals the space between the filter 101 and the horizontal frame element 212. Therefore, air does not flow into the cavity 120 of the first holder frame member 130 from a region around a portion of the filter 101 on the second holder frame member 140.

Operation of Capturing Fine Particles with Capturing Component

As illustrated in FIG. 16A, in the capturing component 100, the filter 101 is disposed below the exhaust opening 82 in a horizontal orientation, and communicates with the exhaust opening 82 through the cavity 120.

In this example, the filter 101 is fixed to the partition frame 21s with the holder 110. The first holder frame member 130 and the blocking member 150 of the holder 110 form the cavity 120 having a sealed structure between the filter 101 and the exhaust opening 82.

Thus, in this example, the filter 101 is disposed in a horizontal orientation and is substantially orthogonal to the exhaust opening 82. When the suction fan 85 of the exhaust mechanism 81 is operated, air is drawn through the exhaust opening 82. The cavity 120 in the holder 110 has a cross-sectional area greater than that of the exhaust opening 82. Therefore, the surface of the filter 101 facing the cavity 120 receives the pressure Pc (negative pressure) that is substantially uniform over the entire area thereof.

Accordingly, the air (including the fine particles p in a vaporized state) around the fixing device 26 flows upward through the filter 101 from the region below the filter 101. Since the air around the fixing device 26 is heated, the upward flow may be effectively used.

In addition, in this example, the air that has passed through the filter 101 flows substantially vertically, and then changes the direction of flow to a substantially horizontal direction to reach the exhaust opening 82. In other words, the air that has passed through the filter 101 flows along a flow passage that is bent at a substantially right angle in the cavity 120 and reaches the exhaust opening 82.

The first holder frame member 130 is fixed to the partition frame 21s at a downstream location in the direction in which the air flows through the filter 101. Therefore, the heat Q of the air that passes through the filter 101 is transmitted to the partition frame 21s through the first holder frame member 130.

The second holder frame member 140 is fixed to the partition frame 21s at a downstream location in the direction in which the air flows through the filter 101. Therefore, the heat Q of the air that passes through the filter 101 is transmitted to the partition frame 21s through the second holder frame member 140.

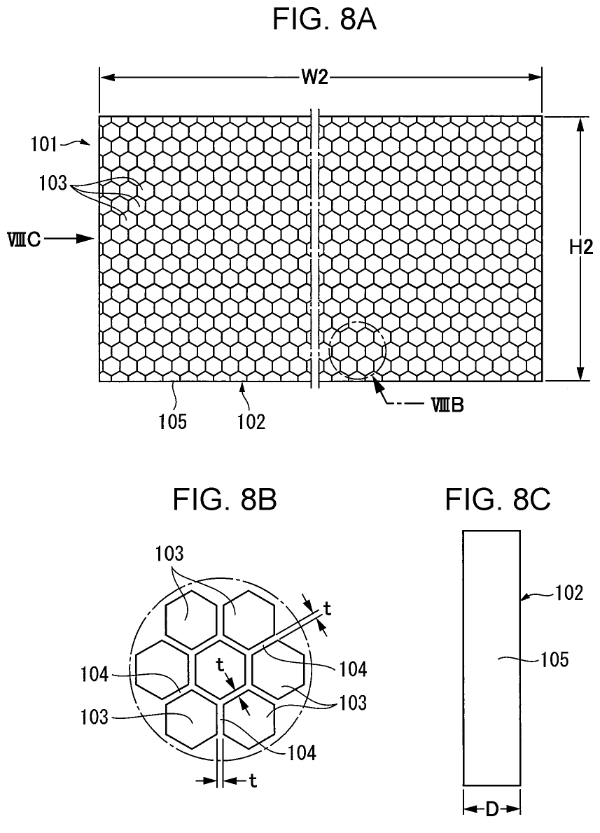

As a result, the temperature of the air passing through the micropores 103 (see FIG. 8) in the filter 101 decreases downstream in the direction in which the air flows. Even when the air passing through the filter 101 includes the fine particles p in a vaporized state, the fine particles p are solidified and captured as the fine particles p pass through the micropores 103.

### Modification 2-1

In the second exemplary embodiment, the holder 110 holds the filter 101 at a position spaced from the exhaust opening 82 with the cavity 120 provided therebetween. In addition, the blocking member 150, which is a component other than the holder 110 disposed around the fixing device 26, is used to maintain the seal the cavity 120 sealed.

However, the blocking member 150 may be omitted, and the structure of the holder 110 itself may be changed.

FIG. 14C illustrates a capturing component according to Modification 2-1.

In this example, the opening 137 in the first holder frame member 130 is blocked by a covering member 151 formed of a rectangular plate member. Also in this example, the capturing component 100 may be effectively used.

### Modification 2-2

In the second exemplary embodiment, the micropores 103 extending in the thickness direction are regularly arranged in the filter 101. However, the direction in which the micropores 103 in the filter 101 extend is not limited to the thickness direction, and may be changed as appropriate.

FIG. 16B illustrates a capturing component according to Modification 2-2.

The basic structure of a capturing component 100 illustrated in FIG. 16B is substantially the same as that in the second exemplary embodiment, but a filter 101 included therein has a structure that differs from that in the second exemplary embodiment.

In this example, similarly to the second exemplary embodiment, the filter 101 is disposed in a horizontal orientation at a position diagonally below the exhaust opening 82.

In this example, the filter 101 has micropores 153 that extend in a direction at an angle of θ relative to the thickness direction of the plate-shaped member 102. In this case, the micropores 153 extend toward the exhaust opening 82. The micropores 153 in this example also have a honey-comb structure that is substantially similar to that in the second exemplary embodiment. The angle θ of the micropores 153 relative to the thickness direction of the filter 101 may be selected as appropriate.

According to the capturing component 100 of this example, the air (including the fine particles p in a vaporized state) around the fixing device 26 flows upward through the filter 101 from the region below the filter 101. Since the micropores 153 in the filter 101 are at an angle of θ, the air passing through the micropores 153 flows in a direction at an angle. The air that has passed through the filter 101 flows toward the exhaust opening 82 without changing the direction.

The performance of the capturing component 100 according to Modification 2-2 (in which the micropores 153 are at an angle of θ) will now be described.

The capturing component 100 according to Modification 2-2 will be compared with the capturing component 100 according to the second exemplary embodiment (in which the micropores 103 extend in the thickness direction).

Assuming that the plate-shaped member 102 having the same thickness is used, the capturing component 100 according to Modification 2-2 has the following advantages.

First, the micropores 153 have a longer ventilation distance.

Second, the air that has passed through the filter 101 flows in the direction toward the exhaust opening 82 in the cavity 120. Therefore, the pressure drop in the airflow is less than when the direction in which the air flows is changed in the cavity 120.

Third, the installation capacity of the capturing component 100 may be reduced.

### Third Exemplary Embodiment

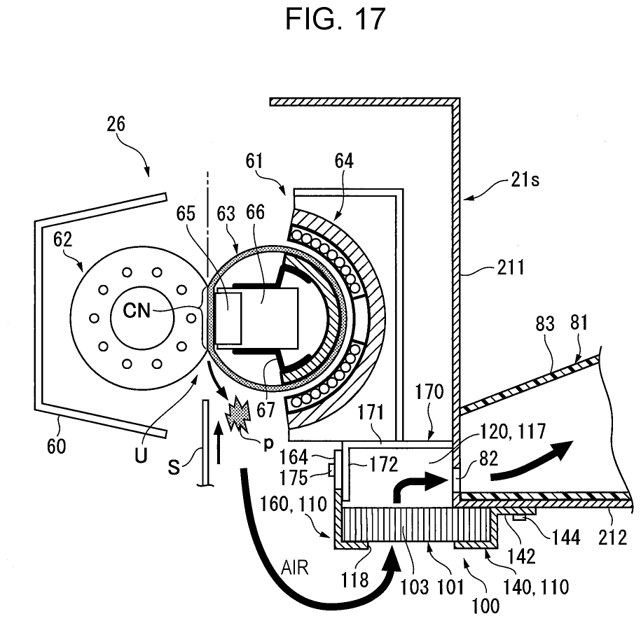

FIG. 17 illustrates an example of the structure of a capturing component included in an exhaust structure around a fixing device according to a third exemplary embodiment.

In FIG. 17, a capturing component 100 according to the present exemplary embodiment includes a filter 101 having a structure similar to that in the second exemplary embodiment, and is disposed in a similar manner as in the second exemplary embodiment. However, the capturing component 100 includes a holder 110 that differs from that in the second exemplary embodiment. Components similar to those in the second exemplary embodiment are denoted by the same reference numerals as those in the second exemplary embodiment, and detailed description thereof is omitted herein.

### Holder

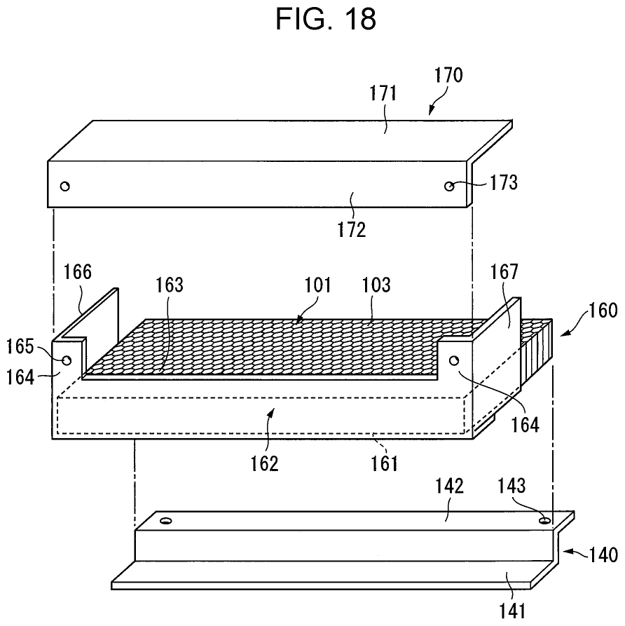

In this example, the holder 110 holds the filter 101 in a horizontal orientation. Referring to FIGS. 17 and 18, in this example, the holder 110 includes two parts (a first holder frame member 160 and a second holder frame member 140).

### First Holder Frame Member

Unlike the second exemplary embodiment, the first holder frame member 160 is attached to a component of the fixing device 26 (for example, the fixing housing 60 or the magnetic-field generator 64).

In this example, the component of the fixing device 26 may be, for example, an attachment bracket 170 of the magnetic-field generator 64 of the fixing device 26.

The attachment bracket 170 is, for example, a plate member made of metal, and is used to attach the magnetic-field generator 64 to the system housing 21 (for example, the partition frame 21s). The attachment bracket 170 includes a rectangular bracket body 171 on which the magnetic-field generator 64 is installed. The bracket body 171 is fixed such that one side edge thereof is in contact with the partition frame 21s. A projecting tab 172 projects downward from a side edge of the bracket body 171 opposite to the side edge in contact with the partition frame 21s. The projecting tab 172 has attachment holes 173.

In this example, the first holder frame member 160 includes a holding frame 161 that holds one side edge of the filter 101 along a long-side direction. An upright wall 162 having a predetermined height is provided on one side edge of the holding frame 161 along the long-side direction. The upright wall 162 has a rectangular cutout 163 in a region excluding both ends thereof in the long-side direction. Attachment tabs 164 that serve as supported portions are formed at both sides of the upright wall 162 with the cutout 163 disposed therebetween, and each attachment tab 164 has an attachment hole 165 formed therein.

A pair of side walls 166 and 167 having a predetermined height are provided on both side edges of the holding frame 161 in the long-side direction. In this example, the side walls 166 and 167 have a substantially rectangular shape with a dimension greater than the width of the holding frame 161 in the short-side direction.

### Second Holder Frame Member

Substantially similarly to the second exemplary embodiment, the second holder frame member 140 is attached to the horizontal frame element 212 of the partition frame 21s.

In this example, the second holder frame member 140 holds a portion of the filter 101 that is not held by the first holder frame member 160.

In this example, the second holder frame member 140 includes a holding bracket 141 having an L-shaped cross-section. An attachment tab 142, which serves as a supported portion, extends substantially horizontally along the upper edge of the holding bracket 141.

### Assembly and Attachment of Capturing Component

In this example, the filter 101 may be attached to the holder 110 as follows. That is, as illustrated in FIGS. 17 and 18, one side edge of the filter 101 along the long-side direction is held by the holding frame 161 of the first holder frame member 160. Next, a portion of the filter 101 that projects from the first holder frame member 160 is held by the second holder frame member 140.

In this example, the filter 101 has a structure similar to that in the second exemplary embodiment (a plate-shaped member 102, micropores 103, and an elastic blocking member 105). Therefore, when the filter 101 is held by the first holder frame member 160, the peripheral edge of the filter 101 is in close contact with the first holder frame member 160. In other words, the peripheral edge of the filter 101 is in close contact with each of the upright wall 162 and the side walls 166 and 167 with the elastic blocking member 105 disposed therebetween. Thus, the space between the peripheral edge of the filter 101 and the first holder frame member 160 is appropriately sealed.

When the filter 101 is held by the second holder frame member 140, the filter 101 is placed on and fixed to a horizontal portion of the holding bracket 141.

As a result, the filter 101 is held by the first holder frame member 160 and the second holder frame member 140.

After that, the attachment holes 165 in the attachment tabs 164 of the first holder frame member 160 are positioned relative to the attachment holes 173 in the projecting tab 172 of the attachment bracket 170. Then, the attachment tabs 164 of the first holder frame member 160 are fixed to the projecting tab 172 of the attachment bracket 170 with fasteners 175.

In this state, the attachment bracket 170 is disposed to cover the top of the first holder frame member 160. The space between the first holder frame member 160 and the attachment bracket 170 may be sealed with an elastic blocking member (not illustrated).

As a result, the first holder frame member 160 and the attachment bracket 170 form a tubular member that surrounds the filter 101 and the cavity 120.

Operation of Capturing Fine Particles with Capturing Component

As illustrated in FIG. 17, in this example, the filter 101 is fixed to the attachment bracket 170, which is a component of the fixing device 26, with the first holder frame member 160.

In addition, the filter 101 is fixed to the partition frame 21s with the second holder frame member 140.

The first holder frame member 160 and the attachment bracket 170 form the cavity 120 having a sealed structure between the filter 101 and the exhaust opening 82.

Thus, in this example, the filter 101 is disposed in a horizontal orientation and is substantially orthogonal to the exhaust opening 82. The lower surface of the filter 101 serves as a capturing opening 118. When the suction fan 85 of the exhaust mechanism 81 is operated, air is drawn through the exhaust opening 82. The cavity 120 in the holder 110 has a cross-sectional area greater than that of the exhaust opening 82. Therefore, the surface of the filter 101 facing the cavity 120 receives the pressure Pc (negative pressure) that is substantially uniform over the entire area thereof.

Accordingly, the air (including the fine particles p in a vaporized state) around the fixing device 26 flows upward through the filter 101 from the region below the filter 101. Since the air around the fixing device 26 is heated, the upward flow may be effectively used.

In this example, the air that has passed through the filter 101 flows along a flow passage that is bent at a substantially right angle in the cavity 120 and reaches the exhaust opening 82.

The first holder frame member 160 is fixed to the attachment bracket 170 at a downstream location in the direction in which the air flows through the filter 101. Therefore, the heat Q of the air that passes through the filter 101 is transmitted to the attachment bracket 170 through the first holder frame member 160, and then to the partition frame 21s.

The second holder frame member 140 is fixed to the partition frame 21s at a downstream location in the direction in which the air flows through the filter 101. Therefore, the heat Q of the air that passes through the filter 101 is transmitted to the partition frame 21s through the second holder frame member 140.

As a result, the temperature of the air passing through the micropores 103 in the filter 101 decreases downstream in the direction in which the air flows. Even when the air passing through the filter 101 includes the fine particles p in a vaporized state, the fine particles p are solidified and captured as the fine particles p pass through the micropores 103.

### Fourth Exemplary Embodiment

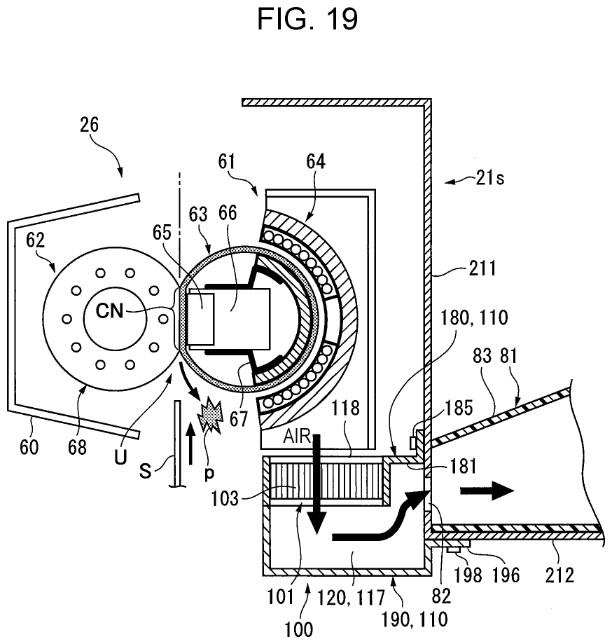

FIG. 19 illustrates an example of the structure of a capturing component included in an exhaust structure around a fixing device according to a fourth exemplary embodiment.

In FIG. 19, a capturing component 100 according to the present exemplary embodiment includes a filter 101 having a structure similar to that in the second exemplary embodiment. However, the position of the filter 101 and the holder 110 in the capturing component 100 differ from those in the second exemplary embodiment. Components similar to those in the second exemplary embodiment are denoted by the same reference numerals as those in the second exemplary embodiment, and detailed description thereof is omitted herein.

### Filter

In this example, unlike the second exemplary embodiment, the filter 101 is disposed in a horizontal orientation at a position close to the fixing device 26. In this example, the filter 101 is disposed in a horizontal orientation substantially at the same position as the position of the exhaust opening 82.

### Holder

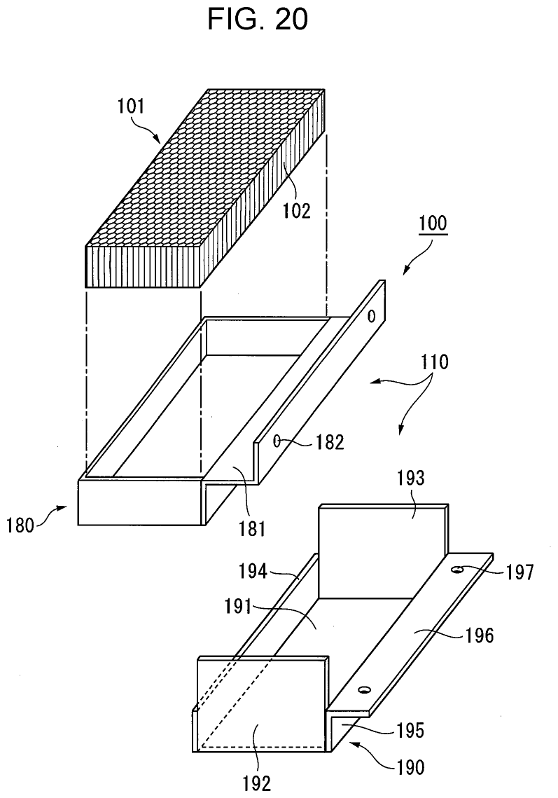

In this example, the holder 110 holds the filter 101 in a horizontal orientation, and air around the fixing device 26 is drawn from above the filter 101. Referring to FIGS. 19 and 20, in this example, the holder 110 includes two parts (a first holder frame member 180 and a second holder frame member 190).

### First Holder Frame Member

The first holder frame member 180 is, for example, a substantially rectangular frame-shaped member formed of a plate member made of metal, such as stainless steel. In this example, the first holder frame member 180 is shaped to be capable of holding a peripheral edge of the filter 101 in a horizontal orientation.

An L-shaped attachment tab 181, which serves as a supported portion, projects from one side edge of the first holder frame member 180 along the long-side direction. The attachment tab 181 includes an upright portion having attachment holes 182.

In this example, the attachment tab 181 of the first holder frame member 180 is fixed to the vertical frame element 211 of the partition frame 21s with fasteners 185.

### Second Holder Frame Member

The second holder frame member 190 includes a substantially rectangular base member 191 and a pair of side walls 192 and 193 extending upward from both sides of the base member 191 in the long-side direction. In this example, a dimension of the base member 191 in the short-side direction is greater than a dimension of the first holder frame member 180 in the short-side direction. A dimension of the base member 191 in the long-side direction is substantially equal to a dimension of the first holder frame member 180 in the long-side direction. In particular, a dimension between the side walls 192 and 193 of the second holder frame member 190 is substantially equal to the dimension of the first holder frame member 180 in the long-side direction.

A pair of partition walls 194 and 195 extend upward from both sides of the base member 191 of the second holder frame member 190 in the short-side direction. In this example, the partition walls 194 and 195 have heights less than those of the side walls 192 and 193. An attachment tab 196 projects horizontally along the upper edge of one partition wall 195. The attachment tab 196 has attachment holes 197.

In this example, the attachment tab 196 of the second holder frame member 190 is fixed to the horizontal frame element 212 of the partition frame 21s with fasteners 198.

### Assembly and Attachment of Capturing Component

In this example, the filter 101 may be attached to the holder 110 as follows. That is, as illustrated in FIGS. 19 and 20, the filter 101 is fitted to and held by the first holder frame member 180. The elastic blocking member 105 is provided on the peripheral edge of the filter 101. Therefore, the space between the peripheral edge of the filter 101 and the first holder frame member 180 is sealed by the elastic blocking member 105.

Next, the first holder frame member 180 holding the filter 101 is fixed to the vertical frame element 211 of the partition frame 21s.

In addition, the second holder frame member 190 is fixed to the horizontal frame element 212 of the partition frame 21s.

In this state, the filter 101 is held by the first holder frame member 180.

The first holder frame member 180 and the second holder frame member 190 are assembled together to form the following structure. That is, the holder 110 defines a passage space 117 through which the filter 101 and the exhaust opening 82 communicate with each other. The holder 110 serves as a tubular member that surrounds the filter 101 and a cavity 120 between the filter 101 and the exhaust opening 82. In particular, in this example, the air that has passed through the filter 101 flows along a bent flow passage to reach the exhaust opening 82. Here, the bent flow passage means the following structure. That is, as illustrated in FIG. 19, the air that has passed through the filter 101 in the horizontal orientation initially flows vertically downward. After that, the air changes the direction thereof to a horizontal direction, and then to a vertically upward direction, and then flows horizontally toward the exhaust opening 82.

When the first holder frame member 180 and the second holder frame member 190 are assembled together to form the holder 110, the assembly may be formed in consideration of the following point. That is, at least the cavity 120 between the filter 101 and the exhaust opening 82 may have a sealed structure.

Operation of Capturing Fine Particles with Capturing Component

In this example, the filter 101 is disposed in a horizontal orientation at a position close to a bottom portion of the heating rotating body 61 of the fixing device 26. When the suction fan 85 of the exhaust mechanism 81 is operated, air is drawn through the exhaust opening 82. The surface of the filter 101 facing the cavity 120 receives the pressure Pc (negative pressure) that is substantially uniform over the entire area thereof.

Accordingly, the air (including the fine particles p in a vaporized state) around the fixing device 26 flows downward through the filter 101 from the region above the filter 101.

In this example, the air that has passed through the filter 101 flows along the bent flow passage in the cavity 120 and reaches the exhaust opening 82.

As described above, in this example, the upper surface of the filter 101 in the horizontal orientation serves as a capturing opening 118, and is disposed close to the bottom portion of the heating rotating body 61 of the fixing device 26. Therefore, the capturing component 100 of this example is capable of capturing the fine particles p at a position closer to the fine-particle source U than in the first to third exemplary embodiments.

In addition, even when the fixing device 26 of this example is reduced in size and components of the fixing device 26 are densely arranged, the capturing component 100 of this example may be easily applied.

The first holder frame member 180 is fixed to the vertical frame element 211 of the partition frame 21s at a downstream location in the direction in which the air flows through the filter 101. The second holder frame member 190 is also fixed to the horizontal frame element 212 of the partition frame 21s at a downstream location in the direction in which the air flows through the filter 101.

Therefore, the heat Q of the air that passes through the filter 101 is transmitted to the partition frame 21s through the first holder frame member 180 and the second holder frame member 190.

As a result, the temperature of the air passing through the micropores 103 in the filter 101 decreases downstream in the direction in which the air flows. Even when the air passing through the filter 101 includes the fine particles p in a vaporized state, the fine particles p are solidified and captured as the fine particles p pass through the micropores 103.

Since the fixing device 26 uses the induction heating method in this example, the capturing component 100 is disposed below the magnetic-field generator 64. However, when a fixing device using a thermal fixing method other than the induction heating method is used as the fixing device 26, the magnetic-field generator 64 may be omitted. For example, when the fixing device includes, as a heating rotating body, a thermal fixing roller in which a heater serving as a heating source is disposed, the capturing component 100 is disposed closer to the thermal fixing roller. Thus, the capturing component 100 may be more flexibly installed; for example, the position of the filter 101 of the capturing component 100 relative to the thermal fixing roller may be appropriately set.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A fine-particle-capturing device including:
a support unit made of metal and disposed near a fine-particle source capable of generating fine particles in a vaporized state;
an exhaust unit having an exhaust opening that opens in the support unit made of metal, the exhaust unit causing air containing the fine particles generated by the fine-particle source to flow in a discharging direction from the exhaust opening; and
a capturing component provided to cover the exhaust opening of the exhaust unit, the capturing component capturing the fine particles,
wherein the capturing component includes
   a capturing unit including a plate-shaped member made of metal in which micropores are regularly arranged, the micropores extending through the plate-shaped member in a thickness direction and having a polygonal cross-section, and
   a holding unit made of metal having a cavity at least in a region between the capturing unit and the exhaust opening, the holding unit holding the capturing unit at a location separated from the exhaust opening, and
wherein the holding unit is supported by the support unit at a downstream location in a direction in which the air passes through the capturing unit.
   (((2)))

The fine-particle-capturing device according to (((1))), wherein the capturing unit includes the plate-shaped member with the micropores having a honey-comb structure.

(((3)))

The fine-particle-capturing device according to (((1))) or (((2))), wherein the capturing unit includes the plate-shaped member made of aluminum.

(((4)))

The fine-particle-capturing device according to any one of (((1))) to (((3))), wherein the capturing unit includes the plate-shaped member having a thickness in a range of 5 to 20 mm.

(((5)))

The fine-particle-capturing device according to any one of (((1))) to (((4))), wherein the capturing unit includes the plate-shaped member having an area greater than an area of the exhaust opening.

(((6)))

The fine-particle-capturing device according to (((5))), wherein a cross-sectional area of the cavity in the holding unit in a direction parallel to the exhaust opening is greater than the area of the exhaust opening.

(((7)))

The fine-particle-capturing device according to (((5))) or (((6))), wherein a length of the cavity in the holding unit in the direction in which the air passes through the capturing unit is greater than a thickness of the capturing unit.

(((8)))

The fine-particle-capturing device according to any one of (((1))) to (((7))), wherein the holding unit includes a tubular member that surrounds the capturing unit and the cavity, the tubular member having a capturing opening at an inlet adjacent to the capturing unit and a communication opening at an outlet that communicates with the exhaust opening.

(((9)))

The fine-particle-capturing device according to (((8))), wherein the holding unit includes a supported portion supported by the support unit at an edge of the communication opening.

(((10)))

The fine-particle-capturing device according to (((8))) or (((9))), wherein the holding unit has the communication opening having a size such that the capturing unit is insertable into the communication opening, and the capturing unit inserted into the communication opening is moved along the cavity and then held near an edge of the capturing opening.

(((11)))

The fine-particle-capturing device according to any one of (((1))) to (((10))), wherein the holding unit causes the air that has passed through the capturing unit to flow to the exhaust opening through a linear flow passage.

(((12)))

The fine-particle-capturing device according to any one of (((1))) to (((10))), wherein the holding unit causes the air that has passed through the capturing unit to flow to the exhaust opening through a bent flow passage.

(((13)))

The fine-particle-capturing device according to (((12))), wherein the capturing unit has the micropores extending in a direction at an angle relative to a thickness direction of the plate-shaped member, and the micropores extend toward the exhaust opening.

(((14)))

A powder-processing system including:
a processing unit including a fine-particle source that generates fine particles in a vaporized state and that processes a processing medium using powder containing the fine particles; and
the fine-particle-capturing device according to any one of (((1))) to (((13))).
   (((15)))

The powder-processing system according to (((14))),
wherein the processing unit includes
   an image forming unit that forms an image on a recording medium serving as the processing medium by using toner as the powder containing wax as the fine particles, and
   a fixing unit that heats and fixes the image formed on the recording medium by the image forming unit, and
wherein the fine-particle-capturing device is provided near the fixing unit.

What is claimed is:

1. A fine-particle-capturing device comprising:
a support unit made of metal and disposed near a fine-particle source capable of generating fine particles in a vaporized state;
an exhaust unit having an exhaust opening that opens in the support unit made of metal, the exhaust unit causing air containing the fine particles generated by the fine-particle source to flow in a discharging direction from the exhaust opening; and
a capturing component provided to cover the exhaust opening of the exhaust unit, the capturing component capturing the fine particles,
wherein the capturing component includes
a capturing unit including a plate-shaped member made of metal in which micropores are regularly arranged, the micropores extending through the plate-shaped member in a thickness direction and having a polygonal cross-section, and
a holding unit made of metal having a cavity at least in a region between the capturing unit and the exhaust opening, the holding unit holding the capturing unit at a location separated from the exhaust opening, and
wherein the holding unit is supported by the support unit at a downstream location in a direction in which the air passes through the capturing unit.

2. The fine-particle-capturing device according to claim 1, wherein the capturing unit includes the plate-shaped member with the micropores having a honey-comb structure.

3. The fine-particle-capturing device according to claim 2, wherein the capturing unit includes the plate-shaped member made of aluminum.

4. The fine-particle-capturing device according to claim 2, wherein the capturing unit includes the plate-shaped member having a thickness in a range of 5 to 20 mm.

5. The fine-particle-capturing device according to claim 1, wherein the capturing unit includes the plate-shaped member having an area greater than an area of the exhaust opening.

6. The fine-particle-capturing device according to claim 5, wherein a cross-sectional area of the cavity in the holding unit in a direction parallel to the exhaust opening is greater than the area of the exhaust opening.

7. The fine-particle-capturing device according to claim 5, wherein a length of the cavity in the holding unit in the direction in which the air passes through the capturing unit is greater than a thickness of the capturing unit.

8. The fine-particle-capturing device according to claim 1, wherein the holding unit includes a tubular member that surrounds the capturing unit and the cavity, the tubular member having a capturing opening at an inlet adjacent to the capturing unit and a communication opening at an outlet that communicates with the exhaust opening.

9. The fine-particle-capturing device according to claim 8, wherein the holding unit includes a supported portion supported by the support unit at an edge of the communication opening.

10. The fine-particle-capturing device according to claim 8, wherein the holding unit has the communication opening having a size such that the capturing unit is insertable into the communication opening, and the capturing unit inserted into the communication opening is moved along the cavity and then held near an edge of the capturing opening.

11. The fine-particle-capturing device according to claim 1, wherein the holding unit causes the air that has passed through the capturing unit to flow to the exhaust opening through a linear flow passage.

12. The fine-particle-capturing device according to claim 1, wherein the holding unit causes the air that has passed through the capturing unit to flow to the exhaust opening through a bent flow passage.

13. The fine-particle-capturing device according to claim 12, wherein the capturing unit has the micropores extending in a direction at an angle relative to a thickness direction of the plate-shaped member, and the micropores extend toward the exhaust opening.

14. A powder-processing system comprising:
a processing unit including a fine-particle source that generates fine particles in a vaporized state and that processes a processing medium using powder containing the fine particles; and
the fine-particle-capturing device according to claim 1.

15. A powder-processing system comprising:
a processing unit including a fine-particle source that generates fine particles in a vaporized state and that processes a processing medium using powder containing the fine particles; and
the fine-particle-capturing device according to claim 2.

16. A powder-processing system comprising:
a processing unit including a fine-particle source that generates fine particles in a vaporized state and that processes a processing medium using powder containing the fine particles; and
the fine-particle-capturing device according to claim 3.

17. A powder-processing system comprising:
a processing unit including a fine-particle source that generates fine particles in a vaporized state and that processes a processing medium using powder containing the fine particles; and
the fine-particle-capturing device according to claim 4.

18. A powder-processing system comprising:
a processing unit including a fine-particle source that generates fine particles in a vaporized state and that processes a processing medium using powder containing the fine particles; and
the fine-particle-capturing device according to claim 5.

19. A powder-processing system comprising:
a processing unit including a fine-particle source that generates fine particles in a vaporized state and that processes a processing medium using powder containing the fine particles; and
the fine-particle-capturing device according to claim 6.

20. The powder-processing system according to claim 14,
wherein the processing unit includes
an image forming unit that forms an image on a recording medium serving as the processing medium by using toner as the powder containing wax as the fine particles, and
a fixing unit that heats and fixes the image formed on the recording medium by the image forming unit, and
wherein the fine-particle-capturing device is provided near the fixing unit.
